(19) United States
(12) Patent Application Publication
(10) Pub. No.: US 2005/0004862 A1
(43) Pub. Date: Jan. 6, 2005

(54) Identifying the probability of violative behavior in a market

(76) Inventors: Dale Kirkland, North Port, FL (US); Cameron Funkhouser, Arlington, VA (US); Dipak Thakker, Rockville, MD (US); Steve Luparello, Alexandria, VA (US); Holly Lokken, Gaithersburg, MD (US)

Correspondence Address: Finnegan, Henderson, Farabow,;Garrett & Dunner, L.L.P., 1300 I Street, N.W., Washington, DC, 20005-3315, US

(21) Appl. No.: 10/843,347

(22) Filed: May 12, 2004

Related U.S. Application Data
(60) Provisional application No. 60/469,842, filed on May 13, 2003.

(51) Int. Cl. G06F 17/60

(52) U.S. Cl. 705/38

(57) ABSTRACT

Systems and methods consistent with the invention for monitoring a market for a predetermined behavior by a market participant (a) receive textual information from a source, (b) extract targeted information from the received information, storing the extracted information in an organized form in a database, (c) compute summary and profile information describing the activity on an issue in the market, storing the summary and profile information in the database, (d) solve a selected equation using targeted information stored in the database relating to the market participant to produce a solution representing a probability that the predetermined behavior has occurred, and (e) adjusting the probability that the behavior has occurred based on the application of one or more expert rules to the targeted information.

### CROSS-REFERENCE TO RELATED APPLICATION

This application claims the benefit of provisional patent application No. 60/469,842, filed on May 13, 2003, the contents of which are incorporated herein by reference.

### FIELD OF THE INVENTION

The present invention relates to the field of stock market surveillance and regulation by the gathering, coordination, and analysis of information to identify the probability of one or more predetermined behaviors within that market.

### BACKGROUND OF THE INVENTION

“Market surveillance” is a term used to describe the monitoring of behavior of participant(s) within a market environment to identify certain types of predetermined behavior. Market surveillance can be used to monitor the behavior of virtually any market, such as a market for the sale of goods, or a market for the trading of stocks or securities. For ease of explanation, the following discussion will focus on market surveillance of a stock or securities markets. The word “securities” includes, but is not limited to, common stock, bonds, rights, warrants, preferred stock, units, options, and futures. Market surveillance may be used to identify virtually any potentially violative behavior such as insider trading or fraud. The goal of a group who conducts market surveillance is to detect and deter any activity that is deemed detrimental to the integrity of the market.

Markets are often examined for various types of fraud such as mini-manipulations, domination and control, and misrepresentation. Mini-manipulations are instances in which a trader or other market participant has manipulated the market by behavior that lasts a very short time, but has disadvantaged other traders in the market. Domination and control occurs when an individual, such as a market maker, has become dominant in a market of a particular security, and uses the dominant position to the disadvantage of others. Fraud by misrepresentation comes in a variety of forms. One form occurs when an issuer of a security disseminates news that is either false or misleading about the business prospects or activities of the company. This is done to “pump” the price of the stock to a higher level. Someone who owns shares in this issue acquired at a lower price can sell at a gain. If the pump was done specifically to benefit a small, targeted list of owners, then this constitutes fraud by misrepresentation.

Another type of illegal market activity, insider trading, occurs when an individual trades on material information not publicly disseminated. Corporate developments are “material” if a prudent investor would make a decision to trade the securities of the corporation based upon knowledge of those developments. Often times, officers, directors, or outside consultants to a company have such information, but current United States law prohibits them from beneficially trading in the security based upon any material information while it is not publicly disseminated. It does not matter whether the person benefiting from knowledge of the information is an officer, director, company employee, or outsider because the law applies to both the “tipper” (person who gave this information to another) and the “tippee” (person who received this information).

Market surveillance typically involves two stages: 1) gathering information related to the market and to the predetermined behavior, and 2) analyzing the information relevant to the market for the predetermined behavior. The analysis stage should identify the probability that a predetermined behavior has occurred. Based on the result, further action may be taken, such as assigning an analyst to further study or review the behavior. When warranted, an analyst will conduct a full-scale investigation of the behavior that can include the taking of testimony from participants.

For more than a decade, analysts have had automated systems that help identify potentially violative market activity, but these systems produced results based solely upon movements in price and volume. The systems did not consider other necessary information about the context in which the movements occurred. The analysts had to conduct manual evaluations of company and industry news, company documents, and company financial information to determine the context of the movement and decide if a potential problem existed. This process is highly labor intensive and requires extensive amounts of reading time to achieve meaningful results.

One known market surveillance tool is SWAT, or Stock Watch Automated Tracking. SWAT was programmed in 1990 to monitor only the Nasdaq Stock Market. SWAT captured price and volume activity and compiled issue profiles from public sources of information about the securities traded on the Nasdaq market. In addition, SWAT captured news stories from four major disseminators of market news, Business Wire, PR News Wire, Dow-Jones and Reuters. Disseminators of news stories are also called vendors of news. SWAT was designed to mimic the way that Nasdaq issuers disseminated material news stories about corporate developments to the investing public. When a news story was received, SWAT recorded its existence, which company was involved in the story, the date and time of the story, and set a flag for the issue to be tested for potential insider trading activity. At the end of each trading day, the SWAT system tested every issue, for which the news flag was set, for potential insider trading activity. The SWAT financial model analyzed mathematically the activity for an issue using the capital asset pricing model (CAP-M) enhanced with logistic regression techniques. If the analysis generated a sufficiently high logistic score for the issue, then the system provided a break or alert to the appropriate analyst.

SWAT had several limitations, however. For example, SWAT could not evaluate the relevance of textual information in text form. Human analysts were needed to determine the relevance of such information as well as of some information derived from price and volume data. Also, SWAT had coded into its programming structure analytic equations that had been designed with only the Nasdaq market in mind. The Nasdaq Stock Market is a dealer market, not an auction market that has different characteristics. To make changes in the mathematical formulas required extensive and expensive changes to program code that took as long as 9 months to complete. It was impossible to adapt properly to changes in market behavior with the necessary speed.

SWAT also limited its statistical analysis to only price and volume activity and the presence or absence of news. SWAT could not parse news stories to extract and store relevant information. In addition, SWAT could not link information from multiple sources: (a) to evaluate the timeframe of information (i.e., whether it was current or historical); (b) to identify relationships among entities identified by the information gathered; or (c) to compare claims made by a company to information about the company from other sources.

For example, if Stock A and Stock B have nearly identical trading history profiles, the SWAT system would treat the two stocks identically for detecting the presence of any unusual activity. The two stocks, however, may have vastly different characteristics that give different significances to the similar trading profiles. For example, if company B was the subject of a merger or acquisition and company A had news that the annual meeting would occur next week, it is much more likely for insider trading to occur in Stock B than in Stock A. The SWAT model could not make this distinction. In addition, because SWAT was designed only for the surveillance of the Nasdaq market, SWAT could not be used to monitor other markets, such as the OTC Bulletin Board, the Pink Sheet, and the Third or CQS markets, without substantial and expensive software modifications. A structural assumption in the design of SWAT was that the inside bid price on a Nasdaq issue was the best indication of the market in an issue. That assumption was valid until the late 1990s, but became suspect until, at times, the inside bid price was not the best indication of the market in that issue. There were a number of instances from about 1999 to 2002 where the closing inside bid price could be extremely far away from the prevailing market. The fundamental assumption on “where the prevailing market was” in an issue changed drastically. A better financial model that minimized built-in assumptions for specific markets was needed.

### SUMMARY OF THE INVENTION

Systems and methods consistent with the invention for monitoring a market for a predetermined behavior by a market participant (a) receive textual information from a source, (b) extract targeted information from the received information, storing the extracted information in an organized form in a database, (c) compute summary and profile information describing the activity on an issue in the market, storing the summary and profile information in the database, (d) solve a selected equation using targeted information stored in the database relating to the market participant to produce a solution representing a probability that the predetermined behavior has occurred, and (e) adjusting the probability that the behavior has occurred based on the application of one or more expert rules to the targeted information.

Both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, help explain the principles of the invention.

FIG. 1 is a block diagram of surveillance system, consistent the present invention, showing one configuration of interrelationships between the system's database and major components;

FIG. 2 is a block diagram of a text mining, extraction and analysis component 100 in FIG. 1;

FIG. 3 is a block diagram of securities data load component 200 in FIG. 1;

FIG. 4 is a block diagram of financial model component 300, consistent with the present invention;

FIG. 5 is a block diagram of watch list component 400, consistent with the present invention;

FIG. 6 is an exemplary presentation screen 401 of a watch list query for use with watch list component 400, consistent with the present invention;

FIG. 7 is a block diagram of ECCO Text Ingestion component 500, consistent with the present invention;

FIG. 8 is a block diagram of expert system component 600, consistent with the present invention;

FIG. 9 is an exemplary presentation screen 900 used by equation editor 301 to edit a factor in a theta equation, consistent with the present invention;

FIG. 10 is an exemplary presentation screen 1000 of one aspect of factor editor 302, consistent with the present invention;

FIG. 11 is another depiction of presentation screen 1000 showing a second aspect of factor editor 302, consistent with the present invention;

FIG. 12 is another depiction of presentation screen 1000 showing a third aspect of factor editor 302, consistent with the present invention;

FIG. 13 is another depiction of presentation screen 1000 showing a fourth aspect of factor editor 302, consistent with the present invention;

FIG. 14 is another depiction of presentation screen 1000 showing a fifth aspect of factor editor 302, consistent with the present invention;

FIG. 15 is another depiction of presentation screen 1000 showing a sixth aspect of factor editor 302, consistent with the present invention;

FIG. 16 is another depiction of presentation screen 1000 showing a seventh aspect of factor editor 302, consistent with the present invention;

FIG. 17 is an exemplary presentation screen 1700 used to display a break, such as may be outputted from equation editor 301 and/or expert system 600;

FIG. 18 is an exemplary presentation screen 1800 including a break 1801 in a particular issue 1802 for the Insider Trading domain;

FIG. 19 is a exemplary presentation screen 1900 showing a break summary for break 1801 (FIG. 18);

FIG. 20 is an alternative presentation screen providing another view of information associated with break 1801;

FIG. 21 is a screenshot of exemplary screen 2100 showing a factor “OROR0_CLS_OLS” and its associated attributes;

FIG. 22 is a screenshot of exemplary screen 2200 showing a second factor “OROR20_RecentFB” and its associated attributes;

FIG. 23 is a screenshot of exemplary screen 2300 showing a third factor “Price_Level_OTCBB_IT” and its associated attributes;

FIG. 24 is a screenshot of exemplary screen 2400 showing a fourth factor “PriceLevel_FRAUD” and its associated attributes;

FIG. 25 is a screenshot of exemplary screen 2500 showing a fifth factor “Dvol/Chg” and its associated attributes; and

FIG. 26 is a screenshot of exemplary screen 2600 showing examples of conditions usable with one or more equations, consistent with the present invention.

### DETAILED DESCRIPTION

Reference will now be made in detail to the present embodiments consistent with the invention, examples of which are illustrated in the accompanying drawings. Wherever possible, the same reference numbers throughout the drawings will refer to the same or like parts. Both the foregoing general description and the following detailed description are exemplary and explanatory only, and do not restrict the invention claimed.

Overview of Surveillance System 50

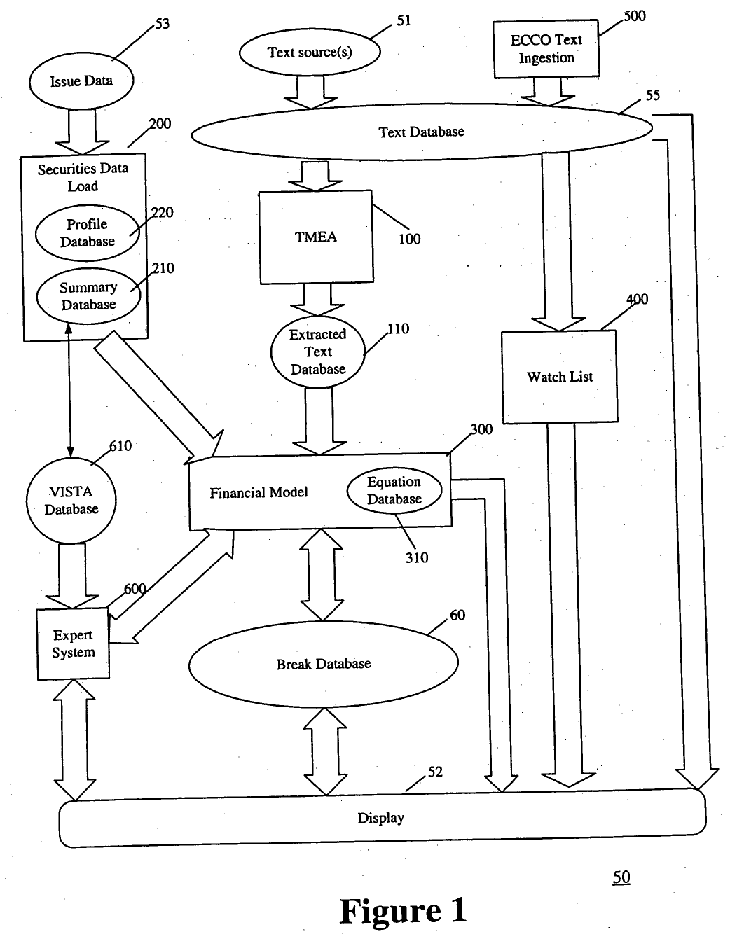

Referring to FIG. 1, market surveillance system 50 consists of six major components, (shown as blocks): text mining, extraction, and analysis (“TMEA”) 100, securities data load 200, financial model 300, watch list 400, evidence collection common output (“ECCO”) text ingestion engine 500, and expert system 600. Each of the components may be implemented as software, hardware or a combination of each. In addition, surveillance system 50 may also include data source(s) 51, display 52, issue/trading data 53, and a set of presentation and/or system administration screens for interaction with systems users for use with display 52 (not shown).

System 50 may also include several databases (shown as circles or ellipses). Text database 55, which is interconnected with system components TMEA 100, watch list 400, and ECCO component 500, stores textual information as it is inputted to system 50. Extracted text database 110, associated with TMEA component 100, stores textual information in an organized format upon processing by TMEA 100, as discussed further below. Summary database 210 and profile database 220, associated with securities component 200, store summary and profile data, respectively, for each security under surveillance. Equations database 310, associated with financial model component 300 stores the theta equations, factors, and conditions for use by component 300. View for Internal Surveillance and Trading Analysis (“VISTA”) database 610, associated with expert system 600, stores quote, detail and summary information. Break database 60, which may be interconnected with one or more of the other databases, contains information about breaks, i.e., alerts to possible violative behavior or other activity under surveillance. One of ordinary skill in the art will recognize that this configuration of databases is exemplary only and that one or more of the databases may be combined, consistent with the principles of the present invention, while still achieving the same functionality. Each of the databases for use with the present invention may be designed, built and maintained using any known or later developed database design methodologies such as the relational database model.

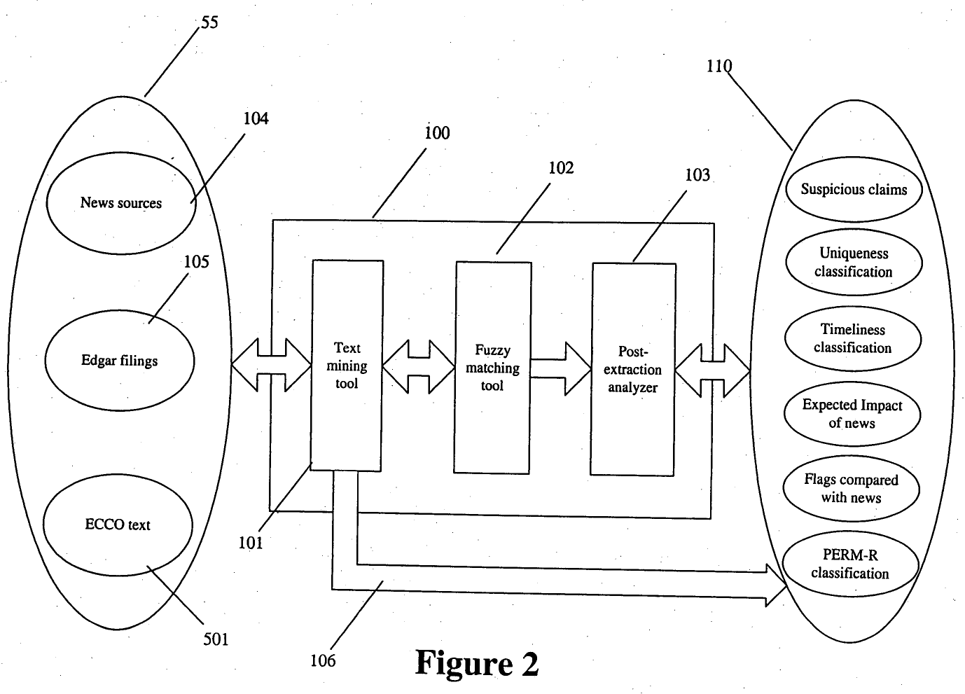

Referring to FIG. 2, TMEA component 100 receives as input textual information from text source(s) 51 that has been stored in text database 55, parses the information to extract particular information, and analyzes the extracted information, storing it in a organized format in extracted text database 110. Possible sources of textual inputs to text database 55 include news sources 104, Edgar filings 105, and information outputted from ECCO component 500. This textual information is processed by a text-mining engine 101, such as ClearLab® from ClearForest, Inc., that parses the data to extract targeted information. A fuzzy matching engine 102 then matches the extracted information to an issue symbol. A post-extraction analysis engine 103 then analyzes and organizes the information by performing such tasks as determining (a) whether this information is current or historical; (b) determining whether the expected impact of the news on the price of the security should be positive, negative, or unknown; and (c) classifying news stories according to the likelihood that they contain insider trading. The information extracted and analyzed by TMEA 100 is stored in extracted text database 110, associated with TMEA 100 in an organized format to reflect the analysis performed.

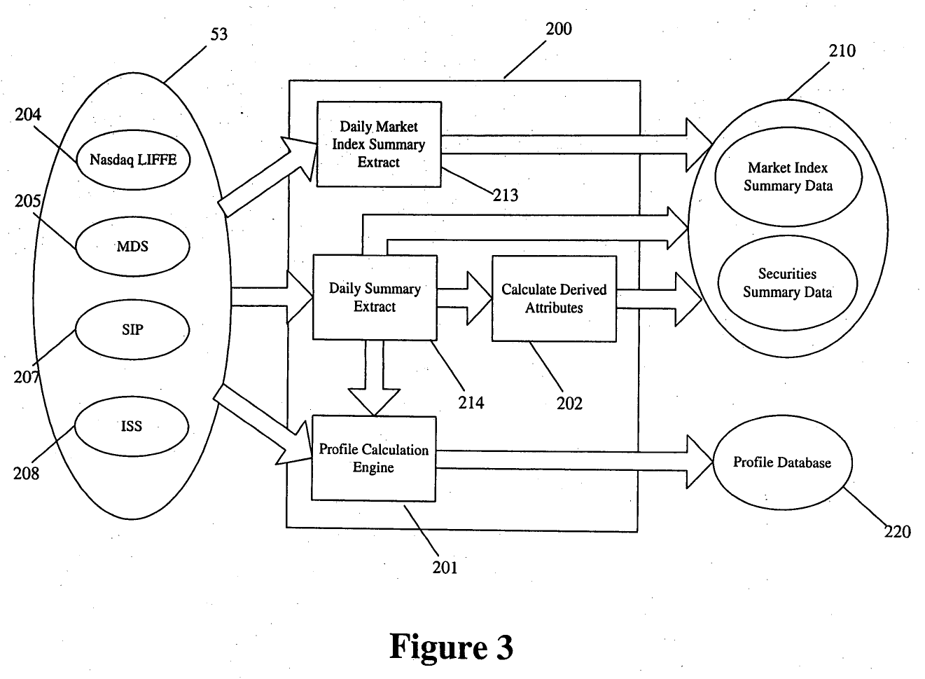

Referring to FIG. 3, securities data load 200 receives detailed trade records from various sources of issue/trading data 53 to store and build periodic (such as daily) price and volume summaries and issue profiles to describe the trading history in each security. The sources of issue/trading data may include market index data or other data from Nasdaq-LIFFE 204, MDS 205, SIP 207, and ISS 208. The summaries and profiles are stored in one or more databases associated with securities data load 200, shown in FIG. 2, summary database 210 and profile database 220. The summaries and profiles from these databases are used to: (a) determine the trading characteristics (such as statistical data) of the issue so that appropriate modeling techniques may be applied; (b) determine whether an issue has trading characteristics that make it more likely to have violative activity; and (c) determine whether recent market movements correspond to market forces that are not normal.

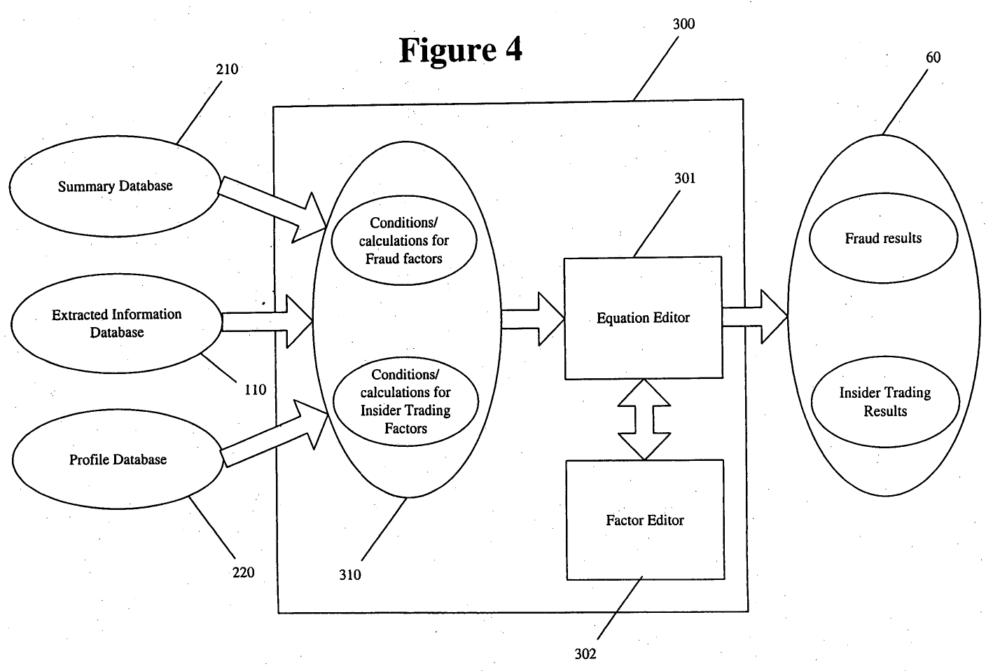

Referring to FIG. 4, financial model 300 consists of a highly flexible and adaptable analyzer that combines the information from extracted text database 110 with summary and profile data from databases 210, 220 to calculate the probability that an analyst should review the tested combination of activity and information. Financial model 300 utilizes a set of programmable (editable) theta equations and a set of programmable (editable) conditions from equations database 310 to statistically analyze the information to determine the probability that the information indicates a particular behavior. Equation editor 301 may be used to add, modify, or delete conditions and equations, and factor editor 302 may be used to add, modify, or delete factors used in the theta equations. Results from financial model 300 may be stored as breaks, near breaks, or less than near breaks (depending on the determined probability) in break database 60.

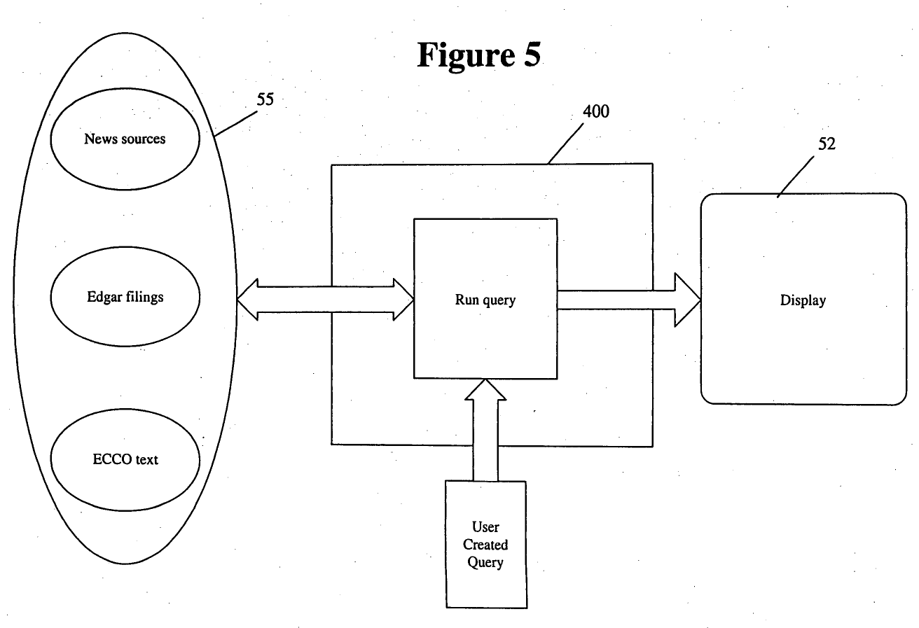

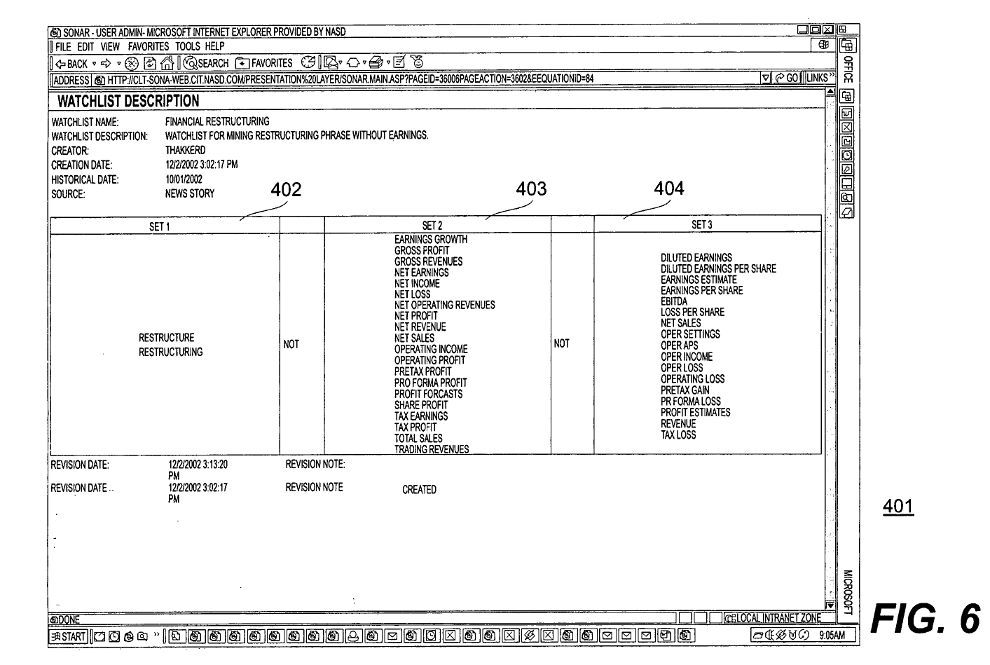

Referring to FIG. 5, watch list 400 is a user interactive tool for defining a query for generating a user alert on the occurrence of any new text inputted into text database 55 or other targeted text that contains information sought through that query. This query may be on-going in that it searches each new, targeted, text file as it is added to the database. Regardless, watch list 400 continually and automatically searches through news, Edgar filings, or other text in the database, and outputs results to display 52 for the analyst to review. FIG. 6 shows an exemplary presentation screen 401 for use with watch list 400. Specifically, 401 shows a query entered by a user for searching for news stories including the words in Set 1, but not including those in Set 2 or Set 3.

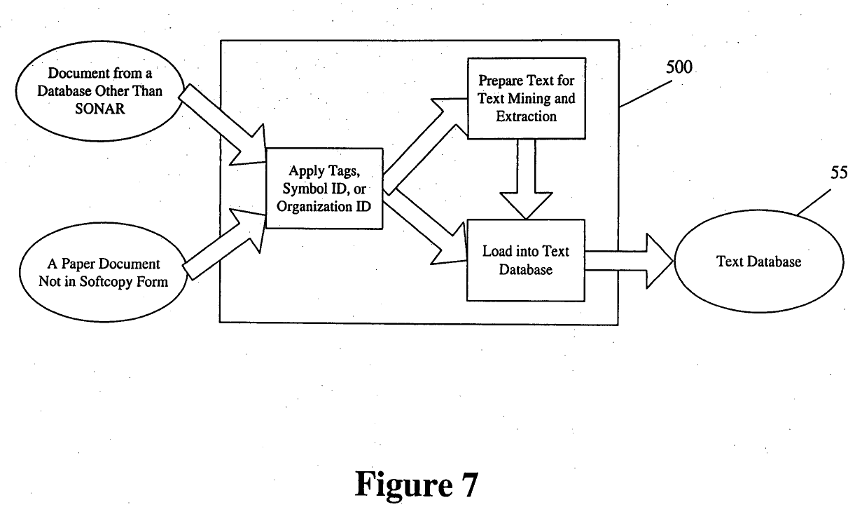

Referring to FIG. 7, Evidence Collection Common Output ingestion engine (“ECCO”) 500 ingests textual information, such as information about past regulatory and disciplinary cases and customer complaints, storing it into text database 55. ECCO 500 helps to quickly find whether the firm or person currently under review has a history of customer complaints, or a history of association with a firm that has been disciplined for violative behavior. ECCO 500 can also be used for other text sources as the need arises.

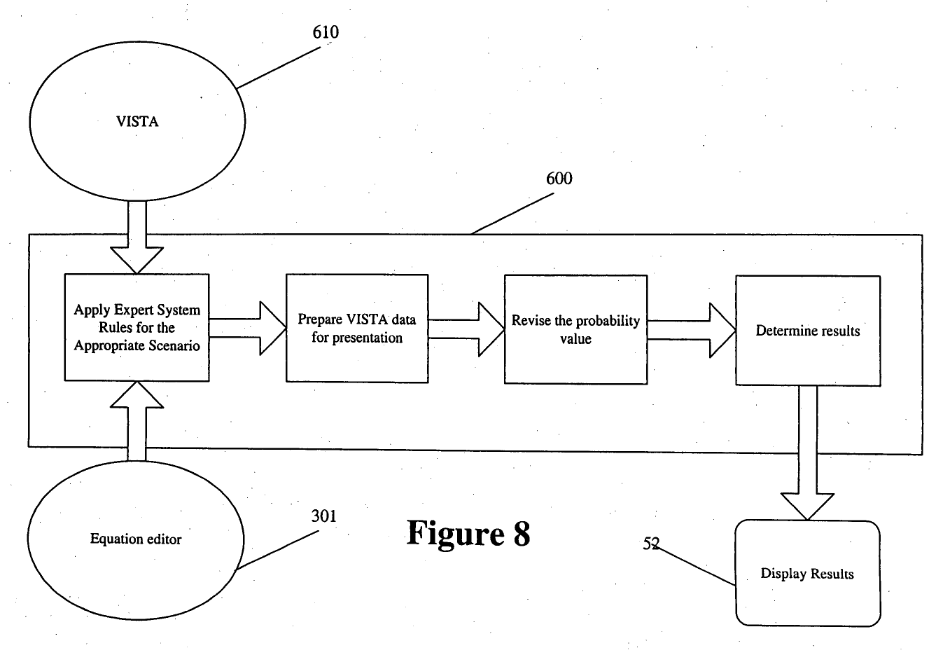

Referring to FIG. 8, expert system 600 is a rule-based expert system tool to handle combinations of data and evidence that are best handled through rules rather than through mathematical calculation, such as situations that are more amenable to if-then-else rules than weighted-average mathematical formulas. Such information on trading in an issue by a member firm may be necessary for surveillance of specific kinds of concerns (e.g., a firm that is trading ahead of research reports that it publishes). Expert system 600 combines results passed on by equation editor 301, and data extracted from NASD's VISTA 610 database for display to the user/analyst. An exemplary software tool for use with expert system 600 is CIAServer® from Haley Enterprises, Inc.

The presentation screens used by system 50 comprise graphical user interfaces, such as those common to any known database engine, and are used to present evidence electronically to a user analyst. FIGS. 6 and 9-26 are each examples of presentation screens for use with the various components of the present invention. An analyst can use these screens to conduct a review of the facts and circumstances concerning potential violative market activity, or to conduct additional queries for more information from any of system 50's databases. The system administration screens permit the system administrator to give groups of analysts or others appropriate permissions to use and/or modify the resources of the system.

Overview of the Market Surveillance Process

The market surveillance process includes detecting breaks (alerts), conducting investigations into the breaks, gathering testimony, or disciplining a member. The break detection process involves the coordination of activities of the various system components beginning with the input of information from system 50's various test sources(s) 51, ECCO text ingestion engine 500 and issue/trading data 53, and then culminating in the presentation of breaks to an analyst for review via display 56.

The break detection process preferably operates as follows. Once information from text source(s) 51, and/or ECCO 500 is inputted to text database 55, TMEA 100 parses the textual information to extract targeted information from the text files storing this information in organized form in extracted text database 110. Securities data load 200 receives issue/trading data from source 53 and computes and stores summary and profile data in databases 210, 220, respectively. Financial model 300 then uses one or more theta equations to analyze the collected data and to test each issue. In certain circumstances (for example, data is needed about a specific broker-dealer's price and volume activity) the processing passes from the financial model 300 to the expert system 600 for completion. Financial model 300 returns a probability that violative behavior has occurred, if the processing is not handed off to expert system 600. Based on the returned probability, a break may be written to break database 60. Each day a user analyst can retrieve the breaks upon request from the break database 60, and conduct an extensive review of the break based on the collected information. The user analyst can then set up a watch list query using component 400, or use the various presentation screens to access the various system databases to seek out additional information on the break.

Details of System 50

System 50 begins with the collection of information in database 55. The information stored in database 55 may be collected from various data sources 51, including data from disseminated news stories 104 about publicly traded companies (i.e., Dow-Jones, Business Wire, PR News Wire, Reuters, PrimeZone, and Internet Wire), from Edgar database 105 (Edgar filings by publicly traded companies in the United States Securities and Exchange Commission such as those accessible at Edgar Online), and from addition, price and volume data, and other textual information 501 (FIG. 2) collected by ECCO ingestion engine 500. Other exemplary sources of information may include referrals to the SEC for disciplinary or legal action, customer complaints, and published disciplinary actions, or any other source of information relevant to the trading of a given security.

Details of Text-Mining, Extraction, and Analysis (TMEA) Tool 100

Referring again to FIG. 2, TMEA 100 processes the information stored in database 55. Preferably, text-mining tool 101 extracts targeted textual or numeric information from text that has structured sentences and can be parsed. A sentence is “structured” if it has a subject, verb, and predicate. In addition to the structure of the sentences, the structure of the source file itself may also preserved because such structure is also likely to convey information. For example, each news story is assumed to contain new information, the most important information likely contained in the top one-third of the story, and historical information likely in the bottom half of the story. Similarly, Edgar filings follow a predetermined structure defined by the requirements of the SEC (requiring a publicly traded company to file certain predetermined kinds of information).

As new data is inputted, each sentence and story is parsed by text mining tool 100. The level of detail with which the text is parsed may be determined by the amount of inputted data. For example, a detailed parsing mechanism may require extensive computing power, time, and complexity for large amounts of text, making it uneconomical.

During the parsing process, text mining tool 101 may collect a variety of information depending on the nature of the market and the potentially violative behavior being targeted. When testing for potential fraud by misrepresentation, textual information should preferably be parsed and text-mined for flags daily, due to the severity of the potential violation. In its simplest form, a flag is a piece of information collected by the system. Such a piece of information may or may not be indicative, by itself, of a particular behavior, such as fraud by misrepresentation. However, as the system text-mines the data for flags, it combines each flag with other information (or flags) relevant to a particular issue, market or behavior. Combining the collected information in this way allows the system to make a determination based on all of the evidence, as to whether a particular behavior is likely to have occurred—in combination with other evidence the flag may increase (support) or decrease (mitigate) suspicions that the behavior has occurred. In this way, the flag is a tool that facilitates piecing together strands of evidence that collectively have weight but individually may be insignificant.

In addition, when testing for potential fraud, text-mining tool 101 will also identify and store information about PERM events 106, which are certain types of news events (Product, Earnings, Regulatory, Merger) about an issuing company that increase the likelihood of insider trading activity. The factor that correlates highest with potential illegal insider trading activity is the nature of the news, specifically that the news is one of four types, referred to as PERM events: (a) a product announcement (P) of major importance to the prospects of the company; (b) an earnings announcement (E) that is not in line with expectations; (c) a regulatory approval (R) or denial of major importance to the prospects of a company; and (d) a merger or acquisition announcement (M), particularly when the company is being acquired. While these classifications are useful to potential insider trading activity, they may also be relevant to other potential violative or abusive market activity such as bear raids (a premeditated attempt by a trader or traders to drive down the price of a security and thereby profit through short selling).

When text mining tool 101 identifies a news story as one of the PERM events, it extracts key concepts from the text of news in text database 55. For a merger/acquisition event, text-mining tool 101 may extract the name of the company doing the buying, the name of the company being bought, the terms of the purchase (e.g., the purchase price offered per share), the timeframe or timeliness of the announcement (e.g., “announced today” or “announced last week”), and the time of the announcement. For a regulatory announcement, tool 101 may extract the name of the company, the timeliness of the announcement, what agency or regulatory body is approving or denying, and what is being approved or denied (e.g., patent application, FDA application on the use of a drug). For a product announcement, tool 101 may extract the name of the company, the timeliness of the announcement, any mention of the impact or importance to the prospects of the company, and the kind of product announced. Finally, for an earnings announcement, text-mining tool 101 may extract the name of the company, the timeliness of the announcement, the time period for the announcement (e.g., annual, quarterly), whether the announcement is for past earnings or future earnings, what was anticipated as the expected earnings, and whether the earnings met, failed to meet or exceeded expectations.

Text database 55 may be designed, built and maintained using any known or later developed database design methodologies such as the relational database model. In one configuration, text database 55 may include a user interface for searching the information in the database using any known techniques and query languages, such as SQL. One example of a database tool that may be used is the Oracle 8i® database application.

When being used to test for potential trading ahead of research reports, text-mining tool 101 may also extract and store information from news stories or research reports that give the member firm name, the issue that is the subject of the research report, and the type of recommendation about the issue in text database 55. This information may be correlated with an expected impact table (not shown on the list of databases) to determine whether the impact of that news on price is expected to be up, down, or flat. For example, the expected impact table may indicate that an initiation of research coverage by a firm on an issue does not generally have any impact, but a downgrade in rating generally does. Trading ahead of research reports is a non-standard type of insider trading that occurs when a member firm publishes a research report and then trades knowingly and beneficially on that information prior to its dissemination.

When attempting to detect potential fraud by misrepresentation, text-mining tool 101 may extract information on representations about certain types of news stories, including, but not limited to: (a) curing any disease or illness (e.g., cure for AIDS); (b) solving a difficult environmental problem (e.g., recycling tires); (c) contracts with companies or organizations at foreign locations; (d) doing profitable business at locations that cannot be checked easily; (e) claims to solving bio-terrorism problems; and (f) claims to discovery in the oil, gas, and mining industries. These types of news stories are called flags for potential fraud, because they are suspicious in and of themselves, particularly if an OTCBB or Pink Sheet company makes the claim. This information may later be compared with information extracted from Edgar filings to help determine if fraud by misrepresentation is likely.

When parsing Edgar filings, text mining tool 101 may extract information such as the names of the officers and directors, the background of the officers and directors, the nature of the business, financial condition of the company, the number and nature of the employees, the name and address of the auditors; and the opinion of the company as expressed by the auditors.

Those of ordinary skill in the art will recognize that the identified types of information extracted from text sources are illustrative only, and not intended to be limiting or exclusive of other types of information. The types of information to be extracted depend largely on nature of the market under surveillance, the types of relevant supporting or mitigating evidence, and the experience of user/analysts.

Text-mining tool 101 may employ any now known or later developed methodologies for text mining electronic or other data. For example, text-mining tool 101 may use either a rule-based approach or a machine learning approach, each of which are well-known forms of Artificial Intelligence. A rule-based approach parses information in a sentence, and applies a system of rules for determining how to store the information. For example, a rule may parse the phrase “Company A is acquiring Company B” by applying rules to identify entities such as Company A and Company B as the participants to which this information relates. The rules may include a word recognition rule to identify any reference to “acquiring” as indicating a news story reporting a merger or acquisition, and linguistic rules to determine that Company A is the subject of the sentence and Company B is the object of the verb “is acquiring.”

The systems and methods consistent with the present invention may also include an extraction rules editor (not shown), such as the one embedded in the ClearLab® tool, to facilitate in modifying existing rules, adding new rules, or deleting old rules. The rules editor may employ any means, such as a database, for storing rules, and may include a user interface for inputting user changes, and modifying existing rules. A text-mining specialist may write specific rules and apply the linguistic properties using the ClearLab® tool. The text-mining specialist should understand the concept of entities, relationships, and events because the underlying extraction process uses that well-known model.

A modification to one or more rules may be input in any way that allows the computer to identify the rule to be modified, receive the modifications and store the modifications. For example, an extraction rules editor embedded in the text-mining tool 101 may employ a user interface to display a list of current rules, and allow the user to select the rule from the list to be modified or deleted. In addition, the user may be able to add a new rule to the list by typing a command from the keyboard, or by clicking on a button associated with the task. The modifications or new rules may then be entered into the computer using any known method, such as importing from a disk, typing from a keyboard, or using any other means of inputting the information now known or later developed. Finally, once the user indicates that the inputs are complete, the interface may save the modified set of rules in a file in a storage device accessible to TMEA 100.

As the information is stored into text database 55, it preferably is associated with all the securities of the issuing company. An issuing company, for example Microsoft, may have numerous securities, such as common stock, rights warrants, preferred options, bonds, and futures, each referred to as an issue. To ensure that the flags or news are associated with each security trading ID of all those securities, the fuzzy matching process 102 checks for the current security symbol ID for the market on which the security trades. If text-mining tool 101 extracts both the company name and the security symbol ID from the news, it can be verified this against a master table of all traded securities (approx. 92,000 issues). If, however, it extracts only the company name, a soundex-based fuzzy matching algorithm (or similar algorithm) may be used to determine the security symbol ID to associate with it. When text-mining tool 101 encounters the name of a privately held company that does not have a security symbol ID, that company can be eliminated from the fuzzy matching check 102 for a security symbol ID.

After the text-mining process 101 extracts information and fuzzy matching process 102 matches the information with the ID symbol, post-extraction analysis process 103 packages the information by providing context and evaluation. During post-extraction analysis 103, the timeliness and/or uniqueness of a news story is determined. “Timeliness” refers to whether the news event is current (i.e., the current day) or historic (i.e., mentioned on one or more prior days). For example, if a merger of two companies is mentioned today, post-extraction analyzer 103 looks for mentions of this same merger on prior days to determine the timeliness of this story with respect to the news event. “Uniqueness” refers to whether the news story is the initial report about a particular news event. It is very important to know when material news is first disseminated to the public and what that news contained. The first story on a news event may not be the first story in a day for that company. Often a writer of news includes historical information that bears no relevance to the current news event. For example, AOL and Time-Warner merged in 1999. In 2002 a quarterly earnings report of that merged company may include a historical mention of the 1999 merger. In this example, it is important that post-extraction analyzer 103 classify the story as a current earning announcement containing historical information and not as a merger/acquisition announcement.

Post-extraction analyzer 103 may also predict the expected impact of the news event. This prediction has three results: (a) the news event is positive and the price should rise; (b) the news event is negative and the price should fall; and (c) the news event cannot be evaluated for the impact (i.e., the predicted impact is unknown). The expected impact is based upon historical occurrences. For example, the impact of a merger/acquisition news event on the company being bought has been positive historically; while the buying company impact has been flat or negative historically.

Examples of rules that may be used by post-extraction analyzer 103 to evaluate the data in the extracted text information database 110 might include a comparison of the size of a company with an earnings announcement. For example, comparing information from a news story that a company has claimed to receive a new contract with annual earnings or the number of employees, it is possible for to determine if the company is likely to be able to handle of contract of that size. Other rules could be used to combine information extracted from multiple sources, such as that individual A is the president of company B, which is the subject of a merger with company C. The rules may also determine whether multiple news stories report the same event, and, if so, which is the first to report that event. The rules may identify whether a news story reports a historical or current event.

One of ordinary skill in the art will recognize that the rules themselves and even the categories of rules that may be employed at this evaluation step can differ significantly. What are important in the context of the systems and methods of the present invention are the functions that the rules perform: comparing, evaluating, or identifying certain information within database 110 to link that information with other information.

The post-extraction analysis tool 103 applies the rules to the information in text database 110. As the rules are applied to text database 110, the information identified by the rules may be linked together to quickly and easily compile the related information identified by the evaluation rules. This linking can be done in any number of ways, such as by adding one or more fields to one or more tables for the purpose of adding a new key to database 110. In addition, a new field can be added to one or more tables representing a pointer to related information. One method for linking information in the database is called the “Link and Edge” method. This method is very similar to the Entity-Relationship database model.

Details of Securities Data Load 200

Referring again to FIG. 3, securities data load 200 is a data-loading tool that calculates a variety of derived attributes. This tool receives as input 53 the results of trading and quoting activity from Nasdaq London International Financial Futures Exchange (LIFFE) 204 (for futures trading information), Market Data Server (MDS) 205 owned by Nasdaq, Inc., Securities Industry Processor (SIP) 207, and ISS database 208 owned by Nasdaq, Inc. (for data about security symbols, dividends and splits, changes in market center location, and new issues). Data may be loaded for all hours including pre-market hours (prior to 9:30 am ET), regular market hours (9:30 am to 4:00 pm ET), and post-market hours (after 4:00 pm ET).

The securities data load component 200 receives detailed trade records from sources 53 of issue/trading data to store and build periodic (such as daily) price and volume summaries 210 and profiles 220 to describe the trading history in each security. The summaries and profiles from the database are then used to: (a) determine the trading characteristics of the issue so that appropriate modeling techniques can be applied; (b) determine whether an issue has trading characteristics that make it more likely to have violative activity; and (c) determine whether recent market movements correspond to market forces that are not normal.

As securities data load 200 gathers price and volume data, it calculates derived attributes 202. A derived attribute is a value calculated to enhance the ability to discover predetermined behaviors. This includes the loading of market index data 213 such as the Standard & Poor's 500 Index and the Nasdaq Composite Index into summary database 210. Securities data load 200 extracts a daily update 214 on the market activity of all issues monitored. It includes an update to the profile data 220 as conditions warrant by profile calculation engine 201. For example, a split or a dividend in an issue means that the historical summary data must be adjusted and the issue profile must be updated.

As securities data load 200 loads data from the sources 53, it calculates the derived attributes 202 therein and stores them in issue summary database 210. These attributes, discussed further below, are largely, but not entirely, based upon of the price and volume activity. The issue summaries from database 210 are used by financial model 300 to evaluate the probability that an analyst should review the evidence that insider trading or fraud by misrepresentation has occurred. A similar process extracts market index data and stored in summary form in the summary database 210 under the symbol ID for the index (i.e., the symbol ID for the Nasdaq Composite Index is IXIC).

An exhaustive list of derived attributes is not provided here. The derived attributes may include the high, low, open, and closing trade (a.k.a. last sale) prices. These prices occur on both dealer and auction markets. The derived attributes may include the high, low, open, and closing BBO (Best Bid and Offer) quotes for dealer markets, cumulative daily volume in an issue, and the natural logarithm of the cumulative daily volume (this logarithm is chosen because the distributional properties are easier to handle in the Theta Equations). The attributes are preferably created by a financial modeler with experience with the distributional properties of factors, because sometimes the distributional properties vary by market, and transformations may therefore be necessary. For example, the volatility of prices on one market can be much less than on another market, and this information should be captured and used properly.

As data are extracted, systems and methods consistent with the present invention prepare an issue summary 214 (e.g., cumulative daily volume, closing last sale price) and an issue profile 201 (e.g., average daily cumulative volume over the last 100 days, daily close to close last sale volatility) storing them in databases 210 and 220, respectively. Every issue that is quoted and/or traded on the Nasdaq Stock Market, the OTC Bulletin Board market, the Pink Sheet market, and the Third Market has a daily or weekly summary of price and volume activity. The data in the summary database 210 is used to derive and store general measures of the trading activity in the security. The results are stored in tables in the profile database 220. Each month the profile data in the security profile database 220 is updated by profile calculation engine 201 to reflect a more recent look back period. Examples of stored profile measures are: (a) the volatility of the closing last sale price of the stock in the past 100 days; (b) the number of days in which trading occurred in the last 100 business days; (c) the average and standard deviation of the logarithm of the cumulative daily volume over the last 100 trading days; and (d) the high and low closing last sale in the past 100 trading days. The first profile value helps to define what is a “more than normal reaction” in the price to news. The second profile value helps to determine whether the issue is actively traded, thinly traded, or sparsely traded. The last profile value helps to answer the question, “Is the stock trading today near its historic high or not?” This list is representative, but far from exhaustive.

A profile is a set of calculated and stored characteristics of daily summaries in an issue. Issue summaries can be used to evaluate and display quickly what occurred in price and volume activity in an issue each trading day. For example, if Issue ABCD traded today on the Nasdaq Stock Market and had 2,500 trade reports during regular market hours and was quoted (i.e., bid and ask) by market makers throughout today, then the summary database 210 would have an entry for today in ABCD with the following data (not exhaustive):
(1) Highest reported trade price;
(2) Lowest reported trade price;
(3) Closing reported trade price;
(4) Opening reported trade price;
(5) Highest inside bid price;
(6) Lowest inside bid price;
(7) Closing inside bid price;
(8) Opening inside bid;
(9) Highest inside ask price;
(10) Lowest inside ask price;
(11) Closing inside ask price;
(12) Opening inside ask price;
(13) Cumulative daily media reported volume;
(14) Cumulative daily reported volume (includes media and non-media reported);
(15) Range of trade prices; and
(16) Number of trades reported.

From this information, securities data load 200 may determine the daily volatility of the closing inside bid price (7) over the past 100 trading days by calculating the standard deviation of the 99 daily rates of return of the consecutive pair-wise closing inside bid prices. It can likewise calculate the standard deviation for the closing reported trade price (3). Each is a well-known approach to calculating volatility that analysts have used for many years. The volatility calculation makes use of two different trimming techniques to prevent extreme outliers from highly perturbing this profile value. The profile value is used to determine whether the current price or volume activity is similar to or dissimilar to the historical profile of activity.

Component 200 may determine how closely the daily closing trade prices in an issue moves with the corresponding daily closing Nasdaq Composite index or daily closing S&P 500 index. This may be performed by a least squares regression on the daily closing index rate of returns against the daily closing price rate of returns, to calculate the degree to which the latter correlates with the former. The resulting number is called an R-Squared value for the issue over the look back period. This calculation is useful in specifying conditions under which a theta equation is to run. It may be stored in profile database 220.

One of the two trimming techniques involves sorting the rate of return data from highest to lowest and tossing out the bottom three and the top three. The other involves sorting the standardized rate of return data from highest to lowest and tossing out the ones whose z-score is beyond a selected value.

On a daily basis, as a report of a split or dividend is received from the ISS database 208, summary database 210 and profile database 220 are updated for the specific security on the basis of the conditions reported in the split or dividend record. Financial modelers may utilize well-known algorithms to adjust the historical price and volume data for splits and dividends.

Details of the Financial Model 300

Financial model component 300 utilizes a set of programmable (editable) theta equations and a set of programmable (editable) conditions from the equations database 310, results from text mining and post-extraction analysis stored in database 110, price and volume data from summary database 210 and the profile database 220, and any information communicated back to the financial model 300 from the expert system component 600. The data from these databases are analyzed to determine the probability that the information indicates a particular behavior. The results from this analysis are then stored as breaks, near breaks, or less-than-near breaks (depending on the determined probability) in the break database 60.

Referring again to FIG. 4, flexible financial model 300 statistically analyzes the information in database 110, including the PERM-R events, expected reaction to the news, the timeliness and uniqueness values, the updated price, volume, and index data from summaries and profiles, the fraud flags from news and Edgar filings, and any supporting or mitigating evidence from ECCO documents. For each issue, financial model 300 determines whether conditions for each theta equation apply. If the conditions apply, then a probability, or equivalently, a logistics score, is calculated using that equation. If the conditions do not apply, then the use of that theta equation is skipped.

When all relevant theta equations are checked, financial model 300 moves to the next issue. If a theta equation is designed to pass information to expert system 600, it does so after calculating a preliminary logistics score. If a logistic score is high enough, then the collected evidence is written as a break to break database 60. If a logistic score is not high enough as a break but is nearly a break, the collected evidence is written as a near break to break database 60. If a logistic score is far from a break, the collected evidence (normally sparse) is written as a less-than-near-break to break database 60. Thus, database 60 collects a history of evidence in the break database whether a break occurred or not.

Financial model 300 includes equations database 310 containing a set of theta equations, factors, and conditions. Each theta equation is associated with one or more of the conditions to determine when it may be used. In addition, each theta equation is associated with one or more factors, which are used to determine, as discussed further below, the probability that a particular behavior has occurred.

The structure of every theta equation is a weighted average function of the form Θ_{(x,y,z)}=C₀+(F₁×C₁)+(C₂×F₂) . . . +(Cₙ×Fₙ). The value of theta (Θ) under conditions x, y, and z is a weighted average of the factors (Fⱼ for j=1 to n) adjusted by the constant C₀. The values C₀, C₁, C₂ . . . Cₙ are called coefficients and the C₀ is called the counterweight or constant and should be negative. Non-counterweight coefficients are used to place weight on each factor in relationship to the constant or counterweight. Some factors are more important than other factors. This approach permits such an adjustment. The values F₁, F₂ . . . Fₙ are called factors. They represent results from the derived attributes, calculations on derived attributes, or results from text mining. Non-numeric data may be encoded in a numeric form. For example, a “4” may represent a news story that reports a merger or acquisition announcement and a “3” may represent an earnings announcement. Thus, in a given theta equation, Fₘ may be the numeric value of the volume of trading on the previous day, Fₘ₊₁ may be standardized score of the last sale price on the previous day, and Fₘ₊₂ may be a numeric encoding identifying the type of news reported for that issue.

The value of Θ is used in the following formula to determine a logistic score, which can be interpreted as a probability since its value must lie between 0 and 1. The graph of this function is a standardized cumulative logistic distribution. The function is defined by LS=1/(1+exp (−1*Θ)), where Θ is the weighted average from above, LS is the logistic score, and exp is the exponential function of base e.

A separate theta equation is used for different market surveillance concerns. To help explain the x, y, and z in Θ_{(x,y,z)}, consider the following example. Let condition x be all those Nasdaq issues whose trading tracks the Nasdaq Composite index at a sufficiently high level; condition y, all those Nasdaq issues that have been trading for more than 30 days; and condition z, all those issues that are very heavily traded with an average daily volume in the past 30 trading days of more than 10 million shares. So a theta equation that includes conditions x, y and z would be used only if all three conditions are satisfied. An important responsibility of the financial modeler is to make sure that all issues are tested appropriately by designing theta equation conditions that are exhaustive in scope. The conditions are not limited to three in number.

From the profile data in database 220, financial model 300 can decide whether to use particular techniques for determining whether current price and/or volume activity is unusual or not. For example, if the R-Squared value for an issue is not sufficiently high, it makes no sense to discount the movement of the price by the movement of a corresponding index. If there are only five days of trading data, the small amount of data would render a mean or standard deviation meaningless.

The factors in a theta equation do not have to be normally distributed. It is universally true that market price and volume data, whether derived or not, is non-normal in distribution. Some data distributions follow a logistics distribution and nearly all have thicker than normal tails (i.e., the kurtosis measure is much larger than three). The factors can contain: (a) results from text mining and post-extraction analysis; (b) derived attributes or values that use derived attributes; and (c) values that simulate a distribution through a step function. One common factor, called the Insider Trading Scenario factor evaluates 81 possible results from four complex factors. The complex factors are: (a) the predicted impact of the news on the price; (b) the trend in price prior to the PERM event; (c) the trend in volume prior to the PERM event; and (d) the actual reaction on the price after the release of the PERM news. Equation editor 301 uses these results from trend calculations, a standardized rate of return calculation for (d), and post-extraction analysis for (a) to determine the Insider Trading Scenario factor for use in the appropriate theta equation. A factor may be, and frequently is, used in more than one theta equation.

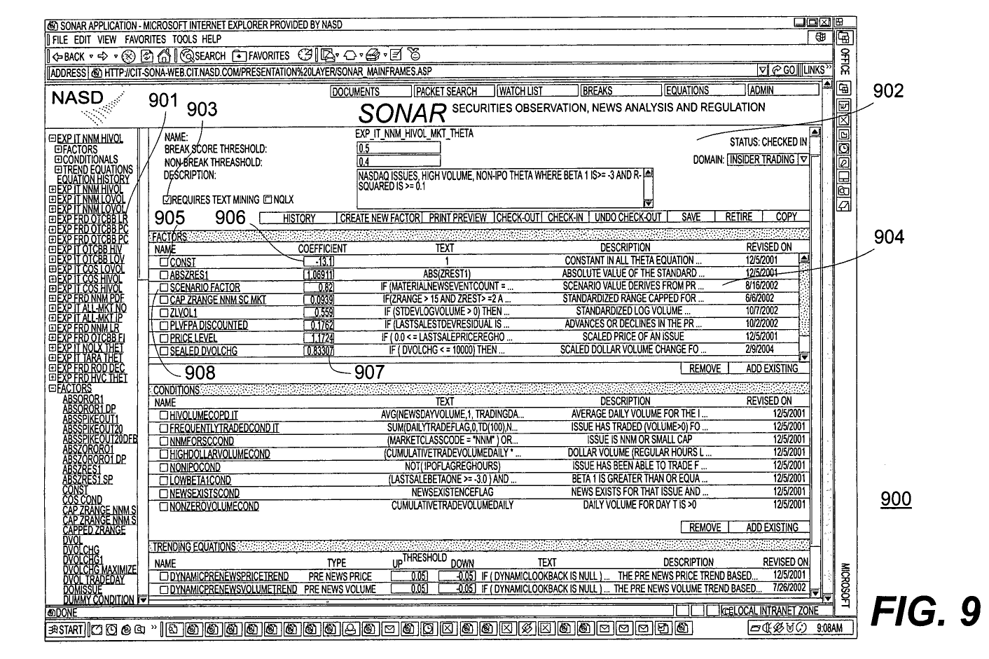

Equation editor 301 allows a financial modeler to define, modify, and retire a specific theta equation. FIG. 9 shows an exemplary screen display 900 for use in equation editor 301. Within screen 900, there is a listing of theta equations along the left side panel 901. An exemplary equation 902, having the name “Exp_IT_NNM_HiVol_Mkt_Theta” is displayed in the large panel in the snapshot of the equation editor. This theta equation makes use of text mining results (notice the check 903 under the label “Requires Text Mining”). It consists of a number of factors listed in frame 904, such as “AbsZRes1” and “Price Level.” There is a counterweight or constant 905 listed with a negative coefficient 906. The other factors have coefficients 907. All coefficients and factors are preferably determined by a financial modeler who works with the regulatory analysts to determine the factors that are important to detection under the given conditions. The set of coefficients can be established by a technique known as logistic regression. Separate statistical packages such as SAS® or SPSS® have programmed routines for performing logistic regression. A key competency of the financial modeler is to define the initial coefficients prior to using any logistic regression packages to find improved coefficients.

The theta equation in frame 902 makes use of trending functions on both price and volume. The trending results are folded into scenario factor 908. Scenario factor 908 helps to define the conditions under which profitable insider trading is likely to have occurred. In this example, equation editor 301 receives four important pieces of information: (a) an indication of whether the news is expected to cause a positive, negative or unknown reaction in price; (b) whether the price trend before the news is up, down, or flat; (c) whether the volume trend before the news is up, down, or flat; and (d) whether the actual reaction to the news was up, down, or flat. If the ordered 4-tuple (negative, flat, down, down) is sent to equation editor 301, then that combination is more important than other combinations of the 81 possibilities. Each of the 81 possibilities have been graded by regulatory analysts and included as a table or database.

The beginning of a trend in price is found dynamically. The invention contains a dynamic look-back algorithm that examines the start of a price trend prior to news. The algorithm uses two exponentially weighted moving average (EWMA) lines to determine where they cross that is five or more business days prior to the news. One EWMA has a two-day composition; the second, a five-day composition. This algorithm has proven to be effective in spotting the start of a trend in price. The NASD financial modelers developed this algorithm.

The source for conditions and factors for a theta equation for an insider trading scenario include: (a) PERM-R events coded into numeric scores, (b) index data appropriate for the market, (c) price and volume summaries, and (d) price and volume historical profiles. These conditions and factors are passed to the equation editor 301 to determine whether an insider-trading break is sent to an analyst.

The source for conditions and factors for a theta equation for a fraud scenario include: (a) price and volume summaries, (b) price and volume historical profiles, (c) claims found in news stories, (d) flags found in Edgar filings, and (e) other supporting or mitigating evidence that was found in text. These conditions and factors are passed to the equation editor 301 to determine whether a fraud break is sent to an analyst.

When a financial modeler creates a theta equation for a particular domain (i.e., for the insider trading team or for the fraud team), both conditions and factors must be selected. The conditions define which theta equation will be selected to run against the data in a particular security. In defining the conditions, a financial modeler may take into consideration the following things:
(a) The market (e.g., NNM, SCM, OTCBB, CQS, NQLX, or Pink Sheet) on which the issue trades because different markets have different characteristics known to the financial modeler;
(b) The length of time the issue has been traded and whether it is actively traded, thinly traded, or very sparsely traded;
(c) The trading behavior of the issue with respect to price and volume level;
(d) Whether the issue has news today or not;
(e) Whether the issue tracks an index or not;
(f) Whether a news story is a research report or not;
(g) Whether a research report is in reaction to recent prior news or not;
(h) Whether an issue traded today or not;
(i) Whether an issue is in the first day of trading or not; and
(j) Whether there is a recent break in the issue or not.

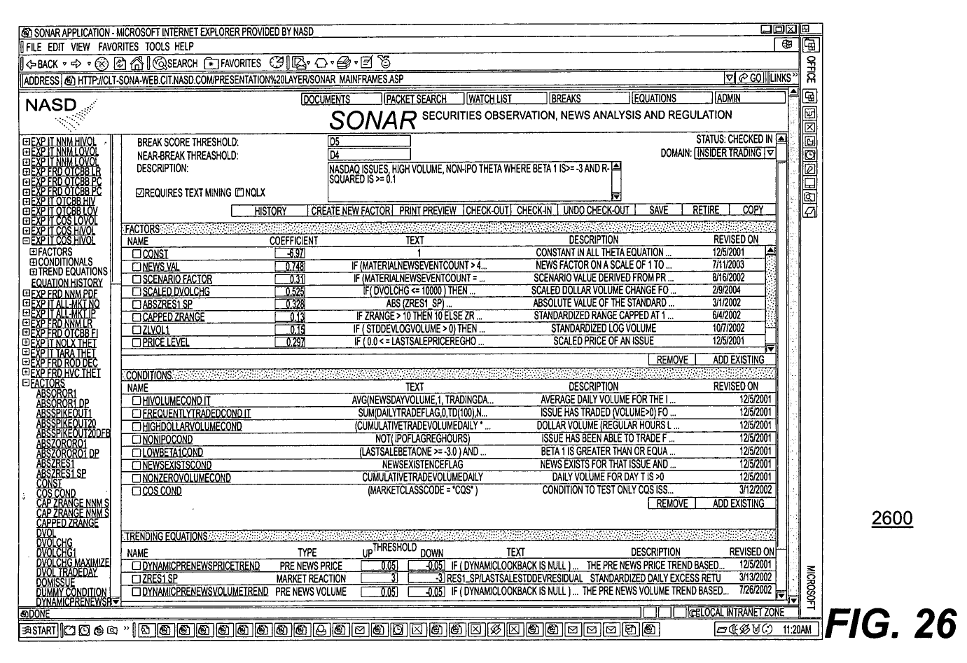

Referring to FIG. 26 under the heading “Conditionals” is a display of eight conditions for a particular theta equation. For example, the CQS condition, named “CQS Cond,” ensures that only issues that trade on the CQS, or equivalently the Third Market, are tested by this theta equation. The conditions are stored in a table as part of the Equations Database 310.

To ensure proper coverage of all issues in a particular market, the financial modeler will define the conditions so that they are mutually exclusive and mutually exhaustive relative to all the conditions of the theta equations that test for a particular scenario. This means that the universe of issues is partitioned in such a way that every issue belongs one and only one partition. A partition of a universe U into n proper subsets Sᵢ is one such that the union of Sᵢ for i=1 to n is U and the intersection of Sᵢ and Sⱼ for any i and j is the empty set. The system need not enforce the concept of mutually exclusive and mutually exhaustive partitions, which may instead be managed by a financial modeler. If the financial modeler has not ensured that all conditions form a partition, then there will be a regulatory surveillance gap.

When the break detection run occurs, the system will check the conditions of a theta equation from database 310 against the current summary 210 and profile 220 data for a particular issue. If all the conditions are satisfied (i.e., each condition returns a “true” result) in a theta equation, then the issue is tested using that theta equation to see if the combination of factors and coefficients yields a probability exceeding a threshold.

A modification to one or more equations may be selected in any way that allows the computer to identify the equation to be modified, receive the modifications and store the modifications. For example, an equations editor 301 may employ a user interface (see FIG. 9) to display a list of current equations, and allow the user to “point to and click on” the equation from the list to be modified or deleted. In addition, the user may be able to add a new equation to the list, by typing a command from the keyboard, or clicking on a button associated with the task. The modifications or new equation may then be entered into the computer using any known method, such as importing from a disk, typing from a keyboard, or using any other means of inputting the information now known or later developed. Once the user indicates that the inputs are complete, the interface saves the modified set of equations in the theta equations database 310.

A financial modeler can choose to modify or add to the conditions of a selected equation. Equation editor 301 may contain a set of predefined conditions that represent concepts commonly used by analysts. A user modifying an equation may select a new equation from the set or may create a new user-defined condition. The user may modify the conditions the adding a new condition to the equation to further limit the use of the selected equation, deleting a condition to broaden its use, or modify an existing condition. Again, the modifications may be made in any manner, by which the user indicates a desire to modify the conditions, select an equation, input modifications, and store the modified equations. As with entering modifications to an equation, modifying the conditions associated with an equation may be done through equation editor 301 employing a user interface designed for the purpose.

Financial model 300 may also contain a factor editor 302. A financial modeler can define a new factor for use in a theta equation. Such a new factor may utilize the data in summary database 210, profile database 220, and/or extracted text information database 110.

Financial model 300 contains a theta equation structure inside equation editor 301. It can be used on data with a non-normal distribution and on data with discrete outcomes. The equation editor takes evidence collected electronically and produces a probability that it is sufficiently suspicious and ought to be reviewed by a human analyst. Several key features of equation editor 301 provide advantages. First, a skilled financial modeler can create a new theta equation that targets existing data and information and place it into production without any software programming changes. Second, a skilled financial modeler has the freedom in the equation editor to design factors to cover the ways that regulatory analysts have viewed the data. Third, if a factor needs to be added, deleted, or replaced then no software change is necessary. Equation editor 301 permits a quick (next day) adjustment to the automated surveillance. Market participants can change their behavior quickly, and this allows quick adaptability in the response and detection.

Using factor editor 302 the financial modeler may perform one or more of the following:

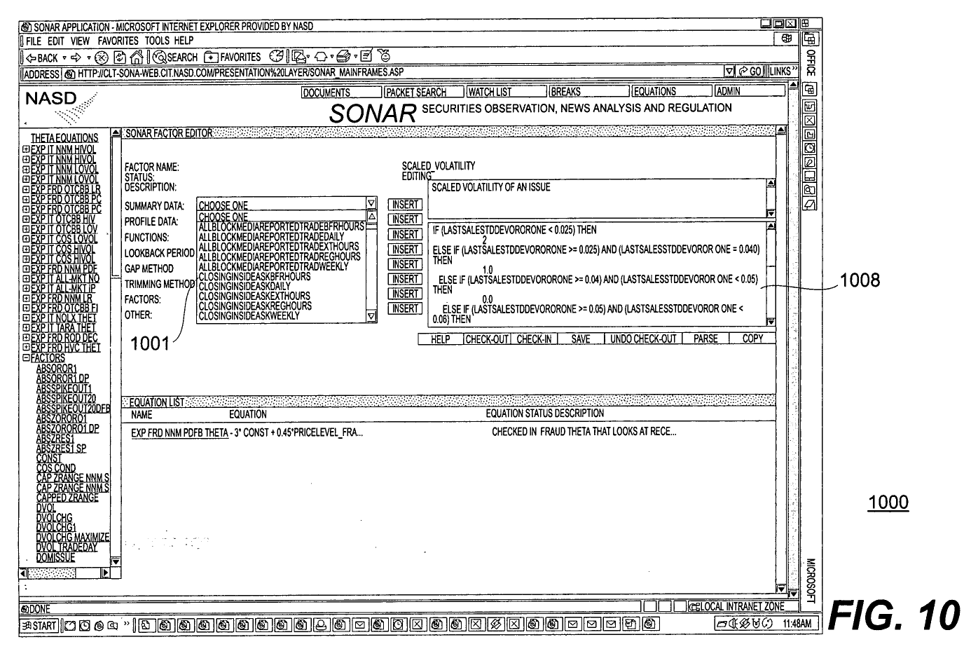

(1) Choose one or more data fields from summary database 210. FIG. 10 shows an exemplary presentation screen 1000 depicting drop down window 1001 for the selection and modification of summary data from summary database 210.

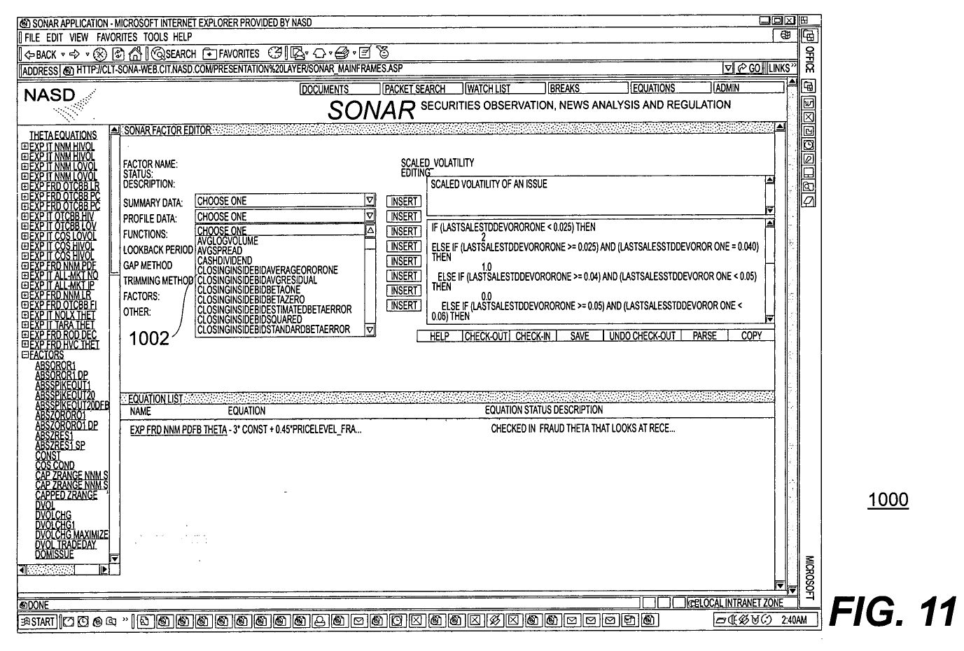

(2) Choose one or more data fields from profile database 220. FIG. 11 again shows presentation screen 1000 highlighting drop down window 1002 for the selection and modification of profile data from profile database 220. One exemplary field (not shown) is the mean of the observed rate of return on closing last sale price over the past 100 days.

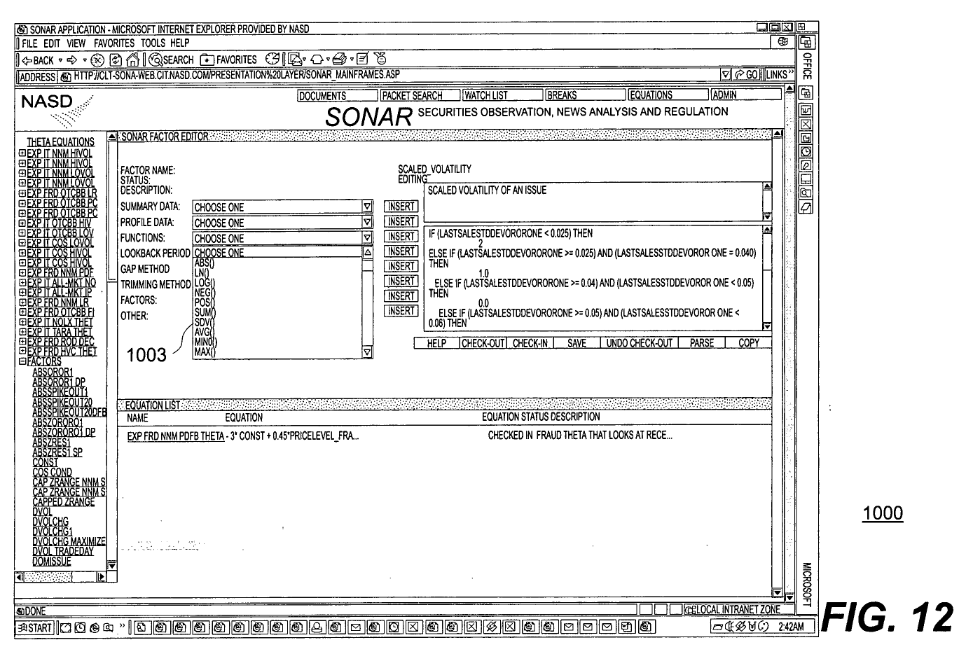

(3) Perform one or more mathematical functions on the selected data field or fields from steps one and two. FIG. 12 again shows presentation screen 1000 highlighting drop down window 1003 for the selection of a mathematical function to use. Exemplary functions are sum, negation, positive, max, min, average, standard deviation, natural log, common log, square root, median, slope, intercept, and absolute value.

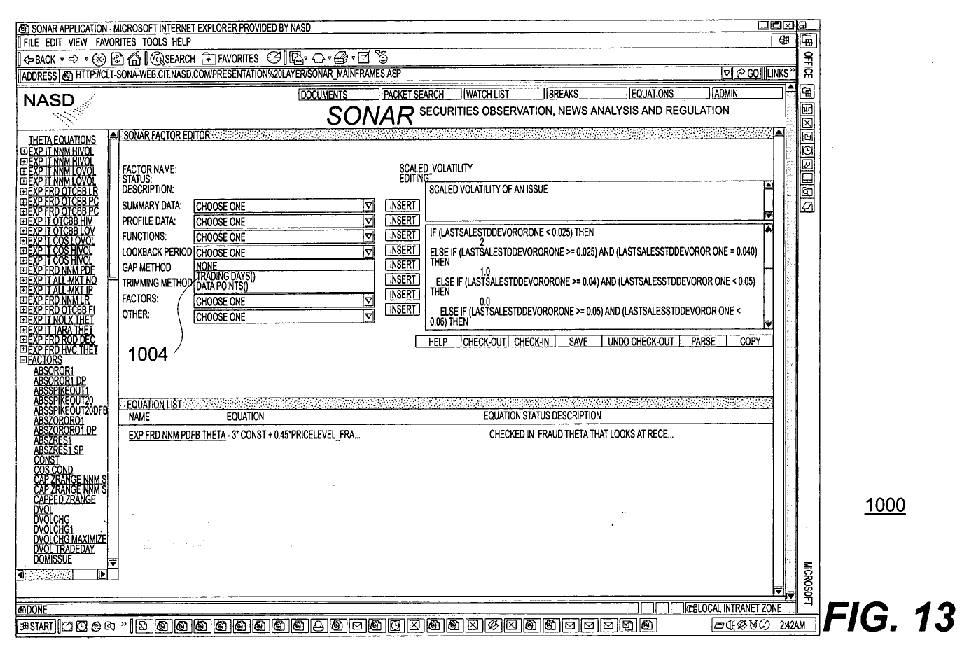

(4) Look back in time and do so either by trading days, or data point days. FIG. 13 again shows presentation screen 1000 depicting drop down window 1004 to the financial modeler for the selection of a method of looking back at historical data. When looking back by trading days (i.e., days the market was open), a day is included if the issue had no activity. In the view by data point days approach, an issue is only shown for days in which it had activity. There are two approaches: (a) by trading days; and (b) by data points.

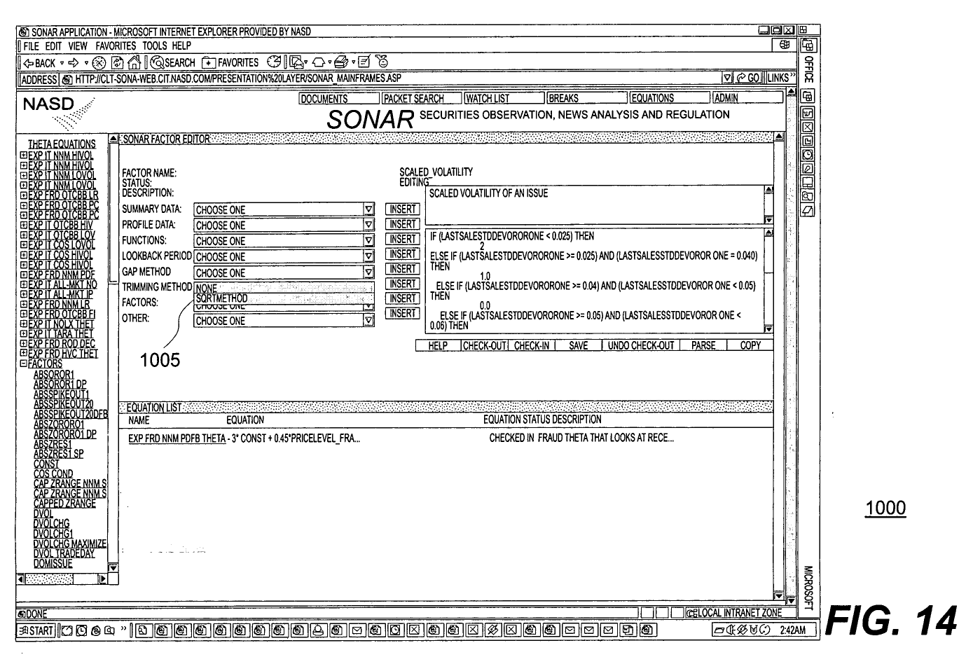

(5) Choose how to handle gaps in trading days. FIG. 14 also depicts presentation screen 1000 including drop down window 1005 for the selection of a method of handling gaps in historical data. It is not infrequent to have issues that go for a number of days without trading. There are two choices for handling these gaps. The first is to do nothing and calculate without gap consideration. The second is to adjust the calculation by the square root of the number of days in the gap, in order to correct the rate of return for gaps of size n between days on which trading occurred.

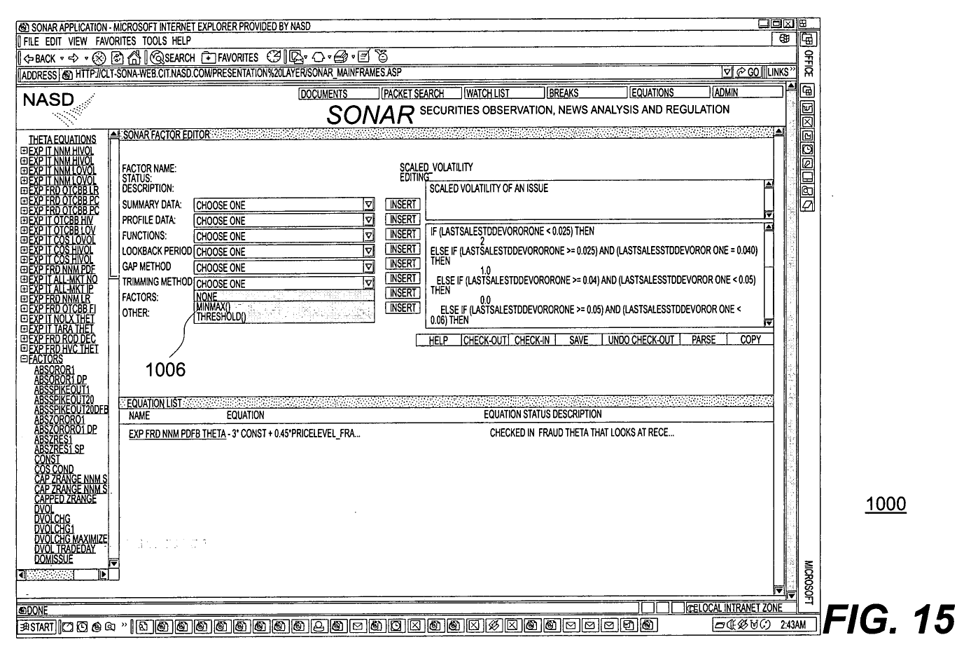

(6) Choose from three approaches to trimming outliers in a distribution. One of the three is to do no trimming and is labeled “None.” FIG. 15 again depicts exemplary presentation screen 1000 highlighting drop down window 1006 to the financial modeler for the selection of a method of trimming outliers from historical data. The purpose is to eliminate from profile calculations extraordinary movements in prices that are not reflective of the normal trading pattern in an issue. The two methods are called: (a) MinMax; and (b) Threshold.

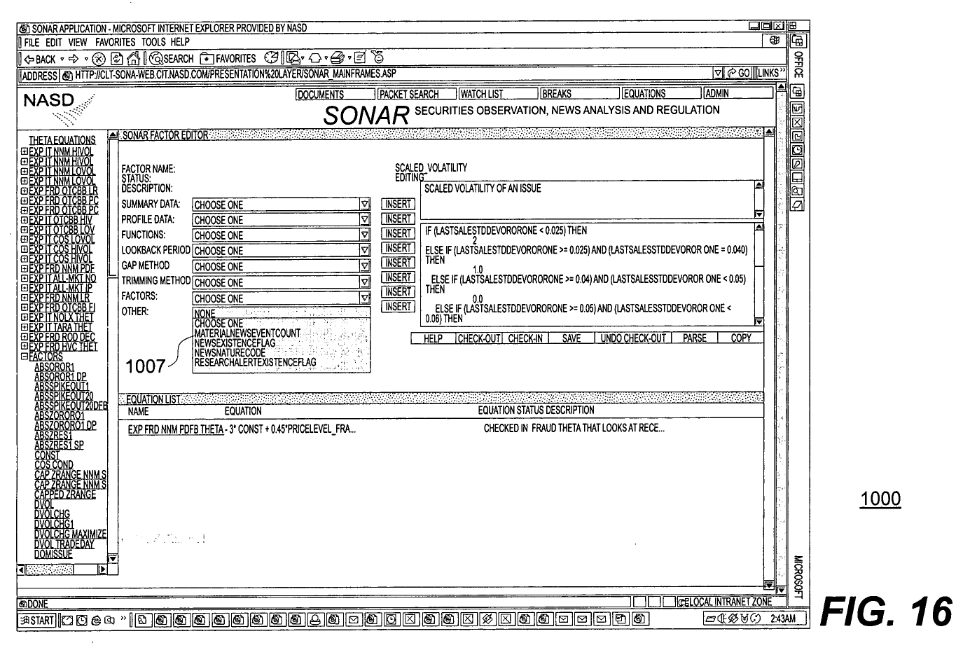

(7) Include results from text mining from a list that has been passed into the equation editor 301. FIG. 16 again depicts exemplary presentation screen 1000 highlighting drop down window 1007 to the financial modeler for the selection of a result from text mining. The choices include: news existence flag; news nature; research alert existence flag; and material news event parameter. From these elements the financial modeler can create a new factor, and/or modify an existing factor.

The modeler can specify an “aggregates on aggregates” calculation which, with limitations, can calculate the composite function g(f(x)) where x is a real number, f(x) is the image of x under the function f, and g(f(x)) is the image of f(x) under the function g. The composition of two functions is needed because there are some calculations in which the results of one mathematical function must be calculated through another mathematical function to obtain needed results. For example, to determine whether the movement of the prices of a security over multiple days fits closely to a trend line or not closely to that trend line requires the composition of two functions.

Factor editor 302, which may be part of equation editor 301, is designed so that the four operations of addition, subtraction, multiplication, and division are recognized with the standard symbols of +, −, *, and/respectively. The parentheses are the symbols for inclusion. The order of operations rule from standard algebra is followed. When no symbols for inclusion define the order, then (a) power-raisings and root-takings take first precedence in order from left to right; (b) multiplications and divisions take next precedence in order from left to right; and (c) additions and subtractions take final precedence in order from left to right. The factor editor handles relational calculus, which means it handles such comparisons as A is greater than B, or C is less than or equal to D, or E is equal to F.

An if-then-else statement that leads to a step function can define a factor. When the modeler specifies a new factor and uses it in a theta equation, the system recognizes what has been done and incorporates this change in the next overnight batch break detection run. No software change is necessary. No software code must be recompiled. The language structure permits parameters for functions that the modeler creates. For example, the modeler can specify that an average include only days on which a trade has occurred and omit days when no trade has occurred.

Referring to FIG. 12, graphical user interface 1201 can be used for editing a factor in a theta equation. An existing factor may be modified by checking it out, which leads to the update mode. Within a screen window, an expression is displayed that defines the factor. The expression may be in any format, or grammar, and it can be modified. In FIG. 12, the expression is an if-then-else statement that defines a step function, used to assign the factor a value based on falling within certain ranges. The format is an extension of a type of BNF grammar that is well known. Another format that may be used is a modified grammar used for calculations in spreadsheets. Appendix A lists one implementation of the grammar's structure, reserved words, and rules for the order of operations.

Once a factor has been checked out, then editing can proceed. Editing may be performed, in this implementation by changing the value in any of the graphical user interface's fields. Once editing is complete, it is necessary to parse the new statement, save it, and check it in prior to making it available to the system for further usage. When the modified factor is checked in, a dynamically generated SQL statement process makes the modification capable of action. The process of generating SQL statements can be performed using any now known or later developed methods. This process permits modified theta equations to run against targeted database tables to produce the leads to analysts of potentially violative market activity.

For example, in FIG. 10, presentation screen 1000 shows that a derived attribute from profile database 220 has been placed into the following step function (called Scaled_Volatility) for use as a factor (“LastSaleStdDevOROROne”) in a theta equation. The factor is the standard deviation of the observed rate of return using one trading day at a time back through at most 100 trading days, and using the closing last sale price. The step function is defined in window 1008. The net effect of this step function is to increase the weight for low volatility stocks and decrease the weight in the theta equation for the high volatility stocks. This factor may be stored in theta equations database 310.

The following is an exemplary list of factors or conditions and their definitions:

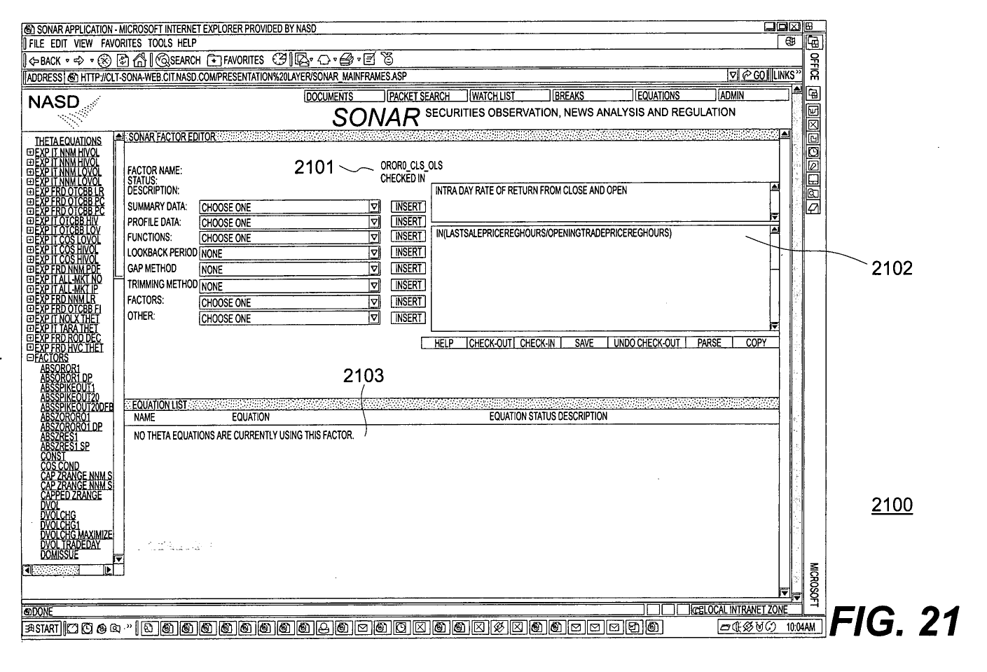

“OROR0_CLS_OLS” is the observed rate of return between the opening trade price in an issue and its closing trade price. FIG. 21 is an exemplary screen 2100 in which the factor OROR0_CLS_OLS is displayed. The name of the factor is displayed as 2101; the formula for this factor is displayed as 2102; and the name of any theta equations in which this factor is used is displayed as 2103. Note that this factor is not used in any theta equation as of the snapshot.

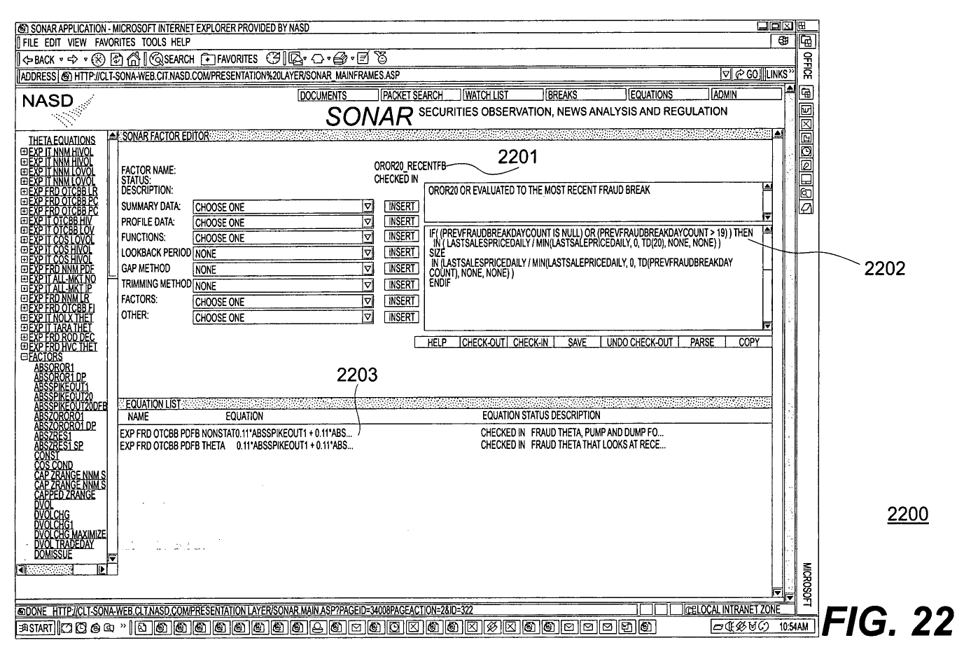

“OROR20_RecentFB” is the observed rate of return using the closing last sale during regular hours for today compared to the minimum closing last sale during regular hours in the past 20 trading days, or to the prior day when there was a fraud type a break. FIG. 22 is an exemplary screen 2200 in which the factor OROR0_RecentFB is displayed. The name of the factor is displayed as 2201, the formula for this factor is displayed as 2202, and the name of any theta equations in which this factor is used is displayed as 2103. Note that this factor is used in two fraud based theta equations as of the snapshot.

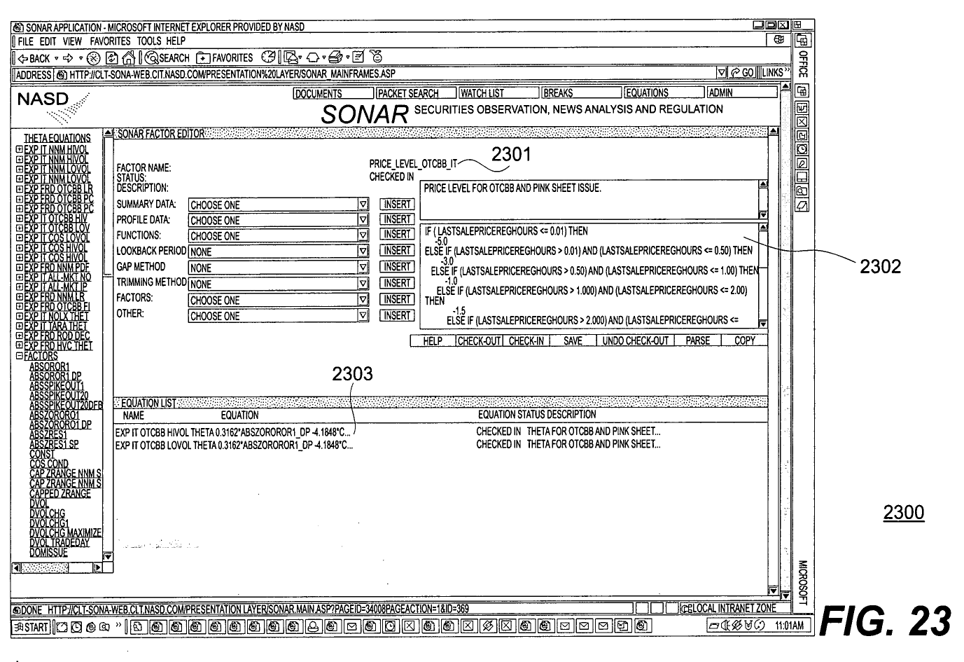

“Price_Level_OTCBB_IT” is the scaled price level for OTCBB and Pink Sheet issues in the context of insider trading, and taking into consideration the low prices that are seen frequently on these two markets. FIG. 23 is an exemplary screen 2300 in which the factor Price_Level_OTCBB_IT is displayed. The name of the factor is displayed as 2301, the formula for this factor is displayed as 2302, and the name of any theta equations in which this factor is used is displayed as 2303. Note that this factor is used in two insider trading theta equations as of the snapshot.

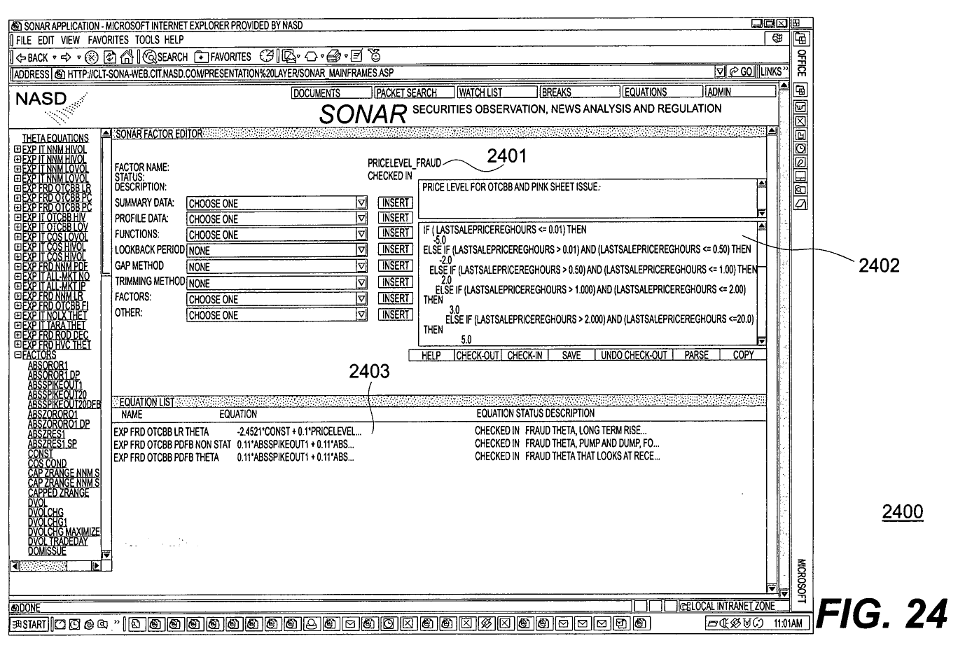

“PriceLevel_FRAUD” is the scaled price level for any issue in the context of the fraud pump and dump scenario. FIG. 24 is an exemplary screen 2400 in which the factor PriceLevel_FRAUD is displayed. The name of the factor is displayed as 2401. The formula for this factor is displayed as 2402. And the name of any theta equations in which this factor is used is displayed as 2403. Note that this factor is used in at least three fraud theta equations as of the snapshot.

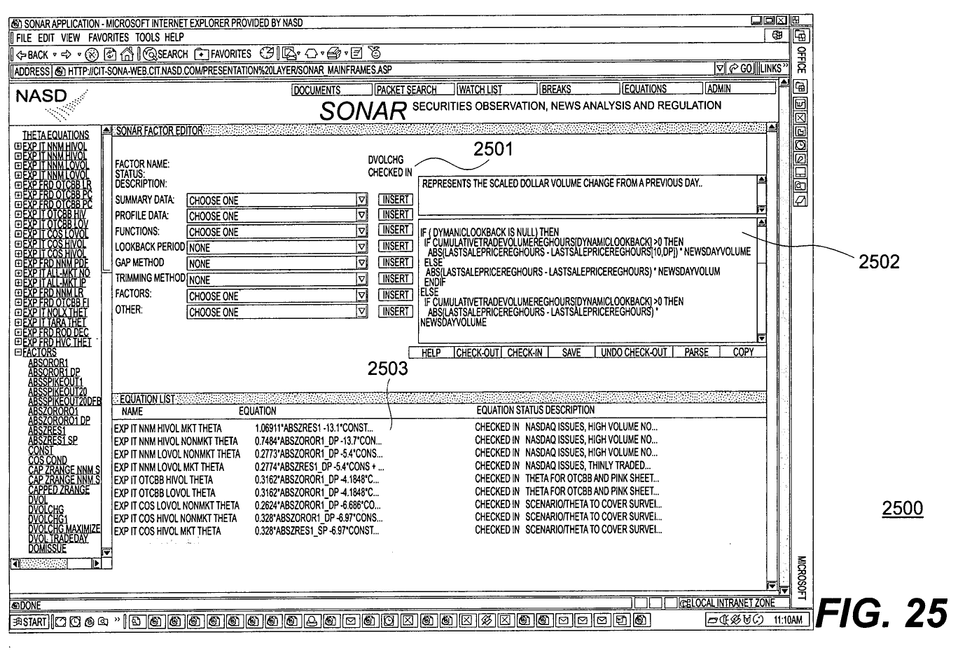

One example of an existing factor, “DvolChg”, identifies significant changes in the amount of money that has changed hands recently. FIG. 25 is an exemplary screen 2500 in which the factor DvolChg is displayed. The name of the factor is displayed as 2501, the formula for this factor is displayed as 2502. And the name of any theta equations in which this factor is used is displayed as 2503. Note this factor is used in at least three theta equations as of the snapshot.

In addition, this example points out the factor editor language and operations mentioned above. The variables are field names that occur in either daily summary database 210 or profile database 220 (the absolute value (abs) function is used). The field labeled LastSalePriceRegHours[10,DP] refers to the closing last sale price in the security at the 4 pm close that was 10 days prior to the current day using the data points method. The field labeled NewsDayVolume is the total cumulative volume, both media reported and non-media reported, from 3:45 pm the prior trading day to 3:45 pm the current trading day (the relational comparison (e.g., x>0) is used). All these elements are supported in equation editor 301, and a change to any one of these does not require a software code change or a recompilation of code into a new executable file.

The factor is written in if-then-else form.

if ( DynamicLookBack is null) then

if CumulativeTradeVolumeRegHours[DynamicLookBack] >0 then

abs(LastSalePriceRegHours − LastSalePriceRegHours[10,DP]) *

NewsDayVolume

else

abs(LastSalePriceRegHours − LastLastSalePriceRegHours) * NewsDayVolume

endif

else

if CumulativeTradeVolumeRegHours[DynamicLookBack] >0 then

abs(LastSalePriceRegHours − LastSalePriceRegHours[DynamicLookBack]) *

NewsDayVolume

else

abs(LastSalePriceRegHours − LastLastSalePriceRegHours) * NewsDayVolume

endif

endif.

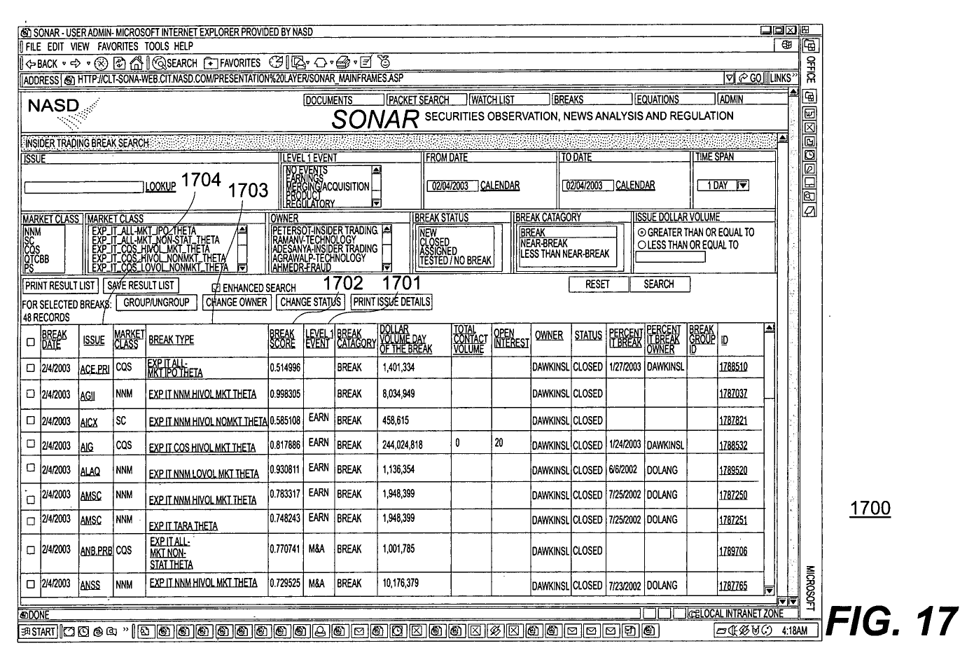

The results produced by financial model 300 are stored in break database 60, as discussed further below, for eventual display to user/analysts using presentation screens such as those depicted in FIGS. 17-20.

Details of Watch List 400

Watch list 400 can be used to define a query and target text files in database 55. The user may use watch list 400 to define a query to look for key words (e.g., the name or trading symbol ID of company that should be watched closely), and to exclude other words, in a targeted set of files (e.g., news story files). The user can define the initial run of a specific instance of a watch list query to look back any number of days up to the amount stored in the database. After an initial run, a watch list query will run against only those files that are added to the database and will bring to the attention of the users only targeted information found. Preferably, watch list 400 runs continually and can provide the analyst with results at anytime.

FIG. 6 shows an exemplary watch list query 401. On the first day (i.e., Dec. 2, 2002) that the query ran, it looked at all news stories back to Oct. 1, 2002. In each succeeding day, watch list query 401 would cover only those news stories that were added to the text database. It would present to the analyst those news stories that met the query requirements. Watch list query 401, called “Financial Restructuring,” searches news stories for mentions of restructuring a company (Set 1, 402), but not in the context of a standard earnings announcement (Set 2, 403, and Set 3, 404).

Details of the Evidence Collection Common Output Tool 500

The Evidence Collection Common Output (ECCO) component 500 (FIG. 7) is a text ingestion engine that receives selected text files into text database 55. Information about past regulatory and disciplinary cases and customer complaints enters database 55 from other historical files or paper sources. This information helps to quickly find whether a broker-dealer or registered person currently under review has a history of customer complaints, or a registered person has a history of association with a broker-dealer that has been disciplined for violative behavior. Furthermore, as new feeds from text sources are added, the ECCO component may be used to enter the text files into text database 55. The purpose is to make the text available for use by the TMEA 100 and the watch list 400 components.

A regulatory analyst or other user may designate a text file, or a stream of text files, to be entered into text database 55 through the ECCO interface 500. For each text file selected for ingestion, the user can specify on a screen (not shown) the name of the company and the security symbol ID associated with the company referenced in the text. The system may take a text file in any one of a number of supported formats (e.g., Microsoft Word, Microsoft Works, WordStar 2000, Lotus Manuscript files, MIME Text Mail) and ingest that text file into the text database 55 under the HTML format. ECCO 500 will preserve the fundamental structure of the text. By this, paragraphs will remain paragraphs; tables will remain tables; headings will remain headings; footnotes will remain footnotes; and indentations will remain indentations. When ECCO has completed an ingestion request, it will signal to the user whether the operation was successfully completed. Exemplary text ingestion tools for use with ECCO tool 300 include AdLib eXpress from AdLib eDocument Solutions, a division of AdLib Publishing Systems, Inc.

In addition, ECCO 500 can include a flexible entry way to add new feeds such as some of the services provided by NewsEdge, a Thomson company, under their Financial SmartWire product. NewsEdge is a consolidator of news services. They bring together feeds from a large number of publishers of information, including Reuters, Business Wire, PR News Wire, PrimeZone, Internet Wire, and Dow-Jones as publishers of business news.

Documents may be ingested by any of the well-known scanning techniques such as one offered by AdLib Publishing Systems, Inc. Any ingested document can be searched via a searching engine, or watch list 400, and can be made available for TMEA 100. Text ingested using ECCO 500 may be included in the evidence gathered as part of breaks generated for analysts.

Details of the Expert System Tool 600

Expert system 600 analyzes evidence that is more rule-based than computational in nature and the data needed is beyond the scope of the equation editor 301. Expert system 600 can retrieve data from a variety of sources.

Expert system 600 may be used wherever there is a need to infer a decision based on business rules along with the preliminary break. The following, non-exclusive list, identifies a few of the rule based decisions that may be implemented using Expert System 600. However, one of ordinary skill in the art will understand and appreciate that expert system 600 may implement any of the rules or decision making criteria relied on in the art.

1) Trading Ahead of Research Alerts (TARA): In this scenario, the invention looks for a violation by a broker-dealer (firm) who positions its own inventory to benefit before issuing a research alert (report). The expert system component 600, in this scenario, collects preliminary break results 60 and related trade data 610 of the broker-dealer who issued the research report and passes through a set of rules. These rules apply to the prior five days buy and sell activities by that particular firm. Separate rules are applied to activities on each day that are based upon whether each buy and sell trade is for the principal account (proprietary account), or a retail account (customer account). Based on these rules, the expert system component 600 makes a decision and adjusts the preliminary logistics score to produce a final logistics score.

2) Short Selling: In this scenario, the invention looks for a potential violation by broker-dealers to drive down the price of a security and profiting from a short position. The expert system component 600 in this scenario collects preliminary break results 60, which indicates a sharp decline in price in the issue, and collects related trade data 610 of all the broker-dealers who traded in that issue. Then this information is passed through a set of rules, which are defined to look at the broker-dealers with heavy selling activities compared to their buying activities. Based on such rules, the expert system component 600 makes a decision and adjusts the preliminary logistics score to produce a final logistics score.

3) Break Suppression: In this category, the expert system component 600 has various business rules implemented to build the bridge between two different business sections (Insider Trading and Fraud). The purpose is to avoid duplicating work between analysts in two different sections. To highlight an example, in certain situations depending on market class, the Fraud team does not want to see a fraud break generated if the facts fit more to the Insider Trading situation and, in fact, there is a break in one of the Insider Trading scenario.

4) Quantifying Suspicious Flags: The text mining and post extraction analysis component (TMEA) 100 detects and collects fraud by misrepresentation evidence from news stories and Edgar filings. In doing so, the Fraud Team targets misrepresentation and false claims by an issuer, its representatives or its promoters.

The expert system component takes this process further by linking all the evidence together and finding discrepancies amongst them. The likelihood of discrepancy in evidence coming from different sources (News vs. Edgar) and different presentation (Text vs. Tabular) is very high for certain categories of market class such as Over-the-Counter or Pink Sheet.

The expert system component 600 uses tuned intelligence in evaluating suspicious flags (false claims or misrepresentation). For example, a company with multi-million dollar revenue making a claim of a million dollar contract looks more genuine than a company with no revenue and one or two employees making a claim of a million dollar contract.

Expert system component 600 may also be used whenever detection must involve summarized data at the member firm level. For example, it was needed to provide trading ahead of research reports breaks to the Insider Trading team. In the trading ahead scenario, a member firm publishes a research report and recommendation about the stock of a publicly traded company, and before the release of this information to the public, the trading department of the member firm positions its proprietary accounts to take advantage of anticipated public reaction to the report.

Securities data load component 200 may do summaries and profiles on issues by member firms. That subdivision of data resides in the NASD VISTA database 6000. Preferably, securities data load component 200 does summaries and profiles by issue, but not by broker-dealer within an issue. This means that if there are 1,000,000 shares traded in issue XYZW, component 2000 does not summarize the number of shares traded by each broker-dealer (e.g., Merrill Lynch). Merrill Lynch may have accounted for 125,000 shares in XYZW in which case they have 12.5% concentration of the total volume in XYZW. The break out by the number of shares traded by each broker-dealer in each issue would instead be done in the NASD database called VISTA.

To detect insider trading at the member firm level, it is necessary to know the buy and sell volume for their proprietary accounts for period prior to the release of the report. That data is passed from VISTA database 610 to expert system 600 for rule analysis. It need not be passed to equation editor 301; the complete calculations and rule evaluations on the issue and broker-dealer data may be done in expert system 600. VISTA 610, View for Internal Surveillance and Trading Analysis, is a database that contains quote and trade data at the detail level, and at various summary levels. Each day approximately 4,000,000 trade records and 30,000,000 quote records are added to the VISTA database.

Expert system 600 may also aggregate data from VISTA database 610 for purposes beyond the trading ahead of research reports scenario. It is useful in aggregating data on the buy-sell ratio at a firm for the bear raid, or equivalently rapid decline, scenario. In the trading ahead scenario, a member firm publishes a research report and recommendation about the stock of a publicly traded company, and before the release of this information to the public, the trading department of the member firm positions its proprietary accounts to take advantage of anticipated public reaction to the report.

Explanation of Break Detection Screens

FIG. 17, shows an exemplary presentation screen 1700 for conveying a lead or break on potential insider trading investigations to a user such as an analyst. The column entitled Levell Event 1701 shows 5 earnings announcements denoted by “Earn” and two merger/acquisition announcements denoted by “M&A.” These results are produced from TMEA 100. The results are communicated to equation editor 301. Column 1702 entitled “Break Score” is a logistic regression score representing the probability that an analyst should review the combination of text mining results and market price and volume activity. Column 1703 entitled “Break Type” gives the name of the theta equation. The analyst can click on underlined items for details. Column 1704 labeled “Issue” provides the security symbol ID for the issue under examination.

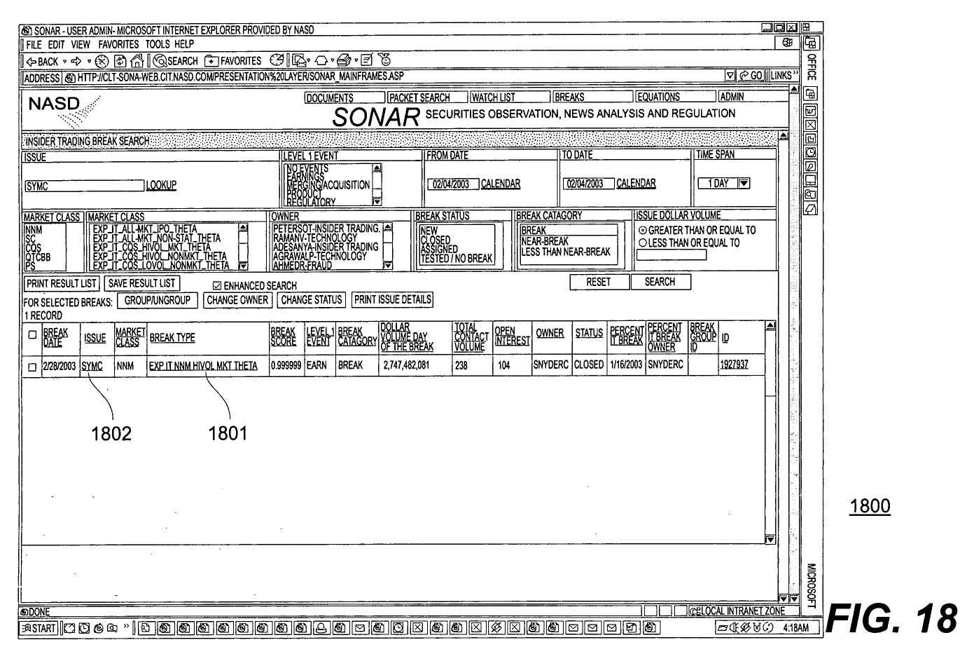

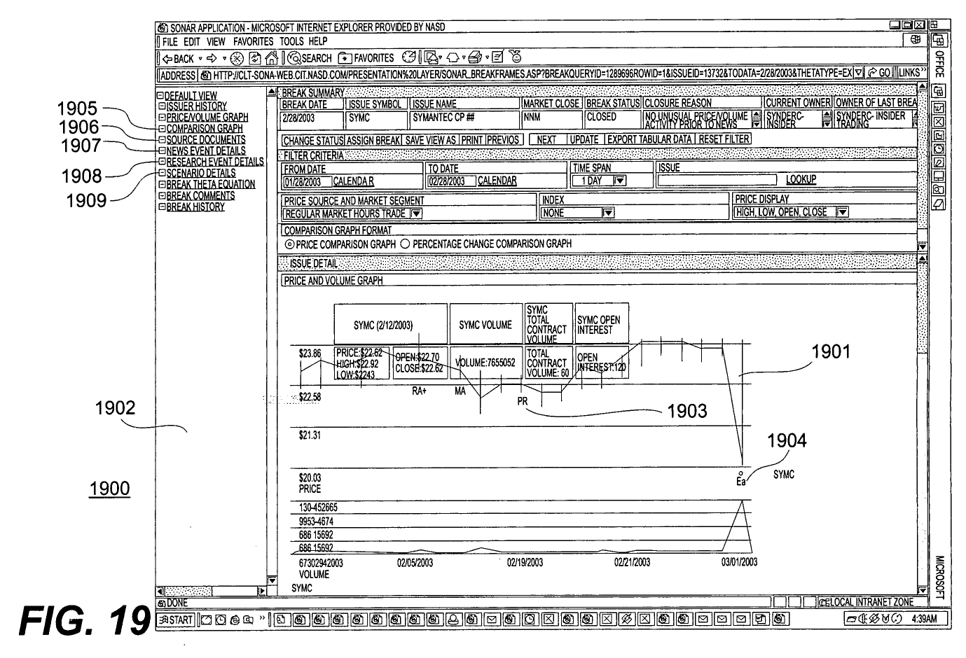

FIG. 18, shows an exemplary user interface 1800 for an Insider Trading Team analyst retrieving a break in a single issue and allowing a user/analyst to drill down for detail. After clicking on the underlined symbol “SYMC” 1801, the analyst will see another interface screen such as that shown in FIG. 19.

FIG. 19 shows a price and volume graph 1901 for a one month period in the selected “SYMC” issue. In this case, surveillance system 50 has collected evidence in a variety of forms. Those forms are listed in the left panel window 1902 as: (a) Price/Volume Graph; (b) Comparison Graph; (c) Source Documents; (d) News Event Details; (e) Research Event Details; (f) Scenario Details; (g) Break Theta Equation; (h) Break Comments; and (i) Break History. Each of these evidentiary collections may be displayed, upon selection, to the user in a variety of ways, as the following examples illustrate.

Price/Volume Graph 1901, presenting a visual picture to the analyst of the trend in closing last sale price with the high and low last sale prices within a day, and of the reaction in price and volume to the news event. An earnings announcement that occurred that day may be denoted by a symbol, such as “Ea” 1904. In this example, there were prior news announcements on prior days including a product announcement “Pr” 1903 as the most recent to the earnings announcement.

The Comparison Graph 1905 may present a visual picture to the analyst of the market reaction of other issues in that industry over the same time span as the issue with the break. This would permit the analyst to see if there were some industry trends or reactions that may have had a bearing of the price reaction in the issue with the break.

The Source Documents option 1906 may present a listing of all news headlines, all Edgar filing titles, and any other text files stored in the text database 55 for that issue during the month prior to the date of the break.

The News Event Details option 1907 may present a listing of all news events or Edgar filing flags for the date of the most recent news event in which information was extracted by TMEA 100 and placed into the information database 110.

The Research Event Details option 1908 may present a listing of data retrieved from VISTA database 610 and additional calculations performed by expert system 600 for the trading ahead of research reports scenario.

The Scenario Details option 1909 may present the outcomes in the analysis of measures that are part of the Scenario Factor in most insider trading theta equations. An example of four measures are: (a) the pre-news price trend; (b) the pre-news volume trend; (c) the expected reaction to the news; and (d) the actual reaction to the news. There are 81 possible results from these four measures because each one produces the outcome of up, down or flat for (a), (b), and (d), and up, down, or unknown for (c).

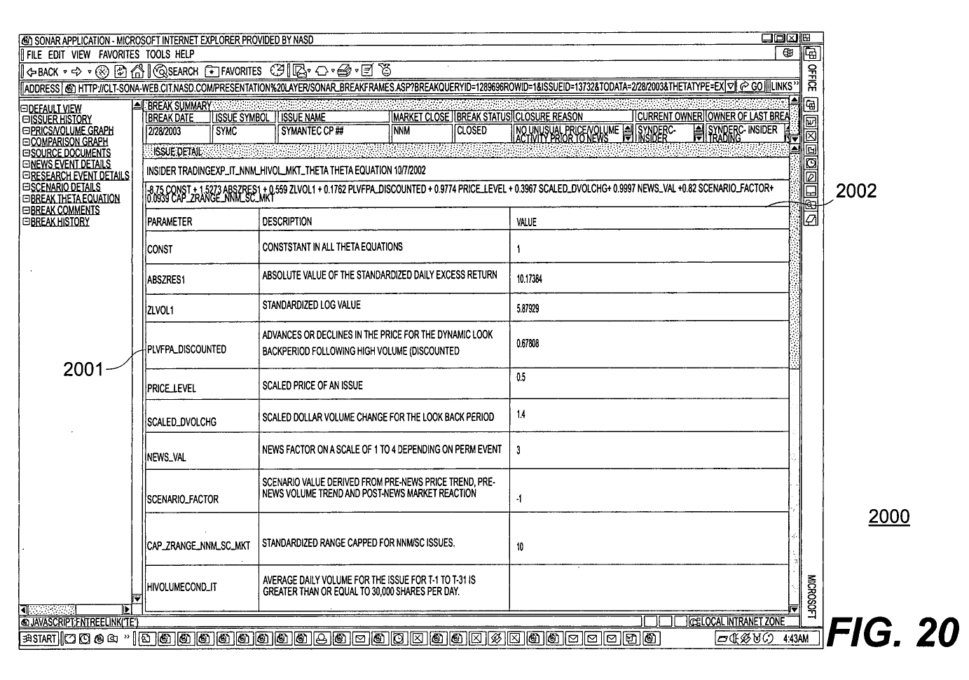

FIG. 20 is an example of a break screen showing the break theta equation option associated with FIG. 18-19. It is entitled “Break Theta Equation for SYMC.” FIG. 20 displays all of the factors under the column heading “Parameter” 2001 with the resulting factor values under the column heading “Value” 2002.

Other displays may be included to display additional information to the user/analyst. For example, a break theta equation option may list the factors and conditions for the theta equation applied in the particular break, and its associated description and value. A break comments option may display comments added by the analyst about the evidence, whether more evidence ought to be pursued, and what actions should be taken or have been taken. The break history option may display all breaks in that issue for period, i.e., a month, prior to the break. Another option may see near-breaks and how the issue was tested for a month, or any prior date within the system.

Other embodiments and implementations consistent with the present invention will be apparent to those skilled in the art from consideration of the specification and practice of the invention disclosed herein. The specification and examples should be considered as exemplary, with a true scope and spirit of the invention being indicated by the following claims.

1. A break detection system for analyzing a behavior of a participant in a market to determine the probability of a predetermined behavior, the system comprising:
a database;
a first component for receiving textual information from a source, extracting targeted information from the received information, and storing the extracted information in an organized form in the database;
a second component for computing summary and profile information describing the activity on an issue in the market, and storing the summary and profile information in the database;
a third component for selecting a theta equation appropriate to the issue, solving the selected equation using targeted information stored in the database relating to the market participant to produce a solution representing a probability that the predetermined behavior has occurred; and
a fourth component for generating an adjusted probability that the behavior has occurred based on the application of one or more expert rules to the targeted information.

2. The system of claim 1, further comprising a fifth component for continually querying the database for additional targeted information, and for generating an alert when the presence of the additional targeted information is detected.

3. The system of claim 1, further comprising a sixth component for ingesting information about past activities of the market participant and associating the ingested information with the targeted information in the database relating to the market participant.

4. The system of claim 1, further comprising a database query tool for querying the database for additional information about the market participant.

5. The method of claim 1, wherein the source is an Edgar filing.

6. The method of claim 1, wherein the predetermined behavior is a trading ahead of research reports behavior.

7. The method of claim 1, wherein the predetermined behavior is fraud.

8. The method of claim 1, wherein the predetermined behavior is a rapid decline scenario.

9. The method of claim 1, wherein the predetermined behavior is an insider trading behavior.

10. The method of claim 1, wherein the third component further comprises a component for selecting a theta equation from a set of programmable theta equations based on the presence of one or more conditions associated with the selected theta equation.

11. A computer-implemented method for monitoring a stock or securities market for a predetermined behavior by a market participant, the method comprising:
parsing textual information to extract targeted information about an issue in the market;
storing the parsed information in a database;
organizing the extracted information with summary and profile information about the issue;
identifying a set of activity conditions under which the activity of the market participant may be tested for the predetermined behavior;
identifying a set of factors that have a highest likelihood of corresponding to the predetermined behavior;
selecting a theta equation from a set of theta equations by matching the identified activity conditions with the equation conditions;
evaluating the selected theta equation using the information stored in the database to determine a probability that the predetermined behavior occurred; and
adjusting the probability based on the application of one or more expert rules to the database information.

12. The computer-implemented method of claim 11, wherein the predetermined behavior is fraud.

13. The computer-implemented method of claim 11, wherein the predetermined behavior is insider trading.

14. The computer-implemented method of claim 11, wherein organizing includes analyzing a timeliness of the textual information and storing an indication of the timeliness in the database.

15. The computer-implemented method of claim 11, wherein organizing includes analyzing an expected reaction to the textual information and storing an indication of the expected reaction in the database.

16. The computer-implemented method of claim 11, wherein organizing includes analyzing a uniqueness of the textual information and storing an indication of the uniqueness in the database.

17. The computer-implemented method of claim 11, wherein organizing includes classifying the textual information as PERM-R information.

18. The computer-implemented method of claim 11, wherein parsing the textual information includes deriving the textual information from a source selected from a group including an Edgar filing.

19. The computer-implemented method of claim 11, wherein parsing the textual information includes deriving the textual information from a source selected from a group including a news story

20. The computer-implemented method of claim 11, wherein parsing the textual information includes deriving the textual information from a source selected from a group including the market,

21. The computer-implemented method of claim 11, wherein parsing the textual information includes deriving the textual information from a source selected from a group including a published research report,

22. The computer-implemented method of claim 11, wherein parsing the textual information includes deriving the textual information from a source selected from a group including an announcement of a market participant,

23. The computer-implemented method of claim 11, further comprising calculating one or more derived attributes from the extracted information.

24. The computer-implemented method of claim 11, wherein evaluating the selected theta equation comprises
calculating a factor associated with the theta equation;
calculating a weighted average using the calculated factor and a coefficient associated with the factor;
calculating the probability that the weighted average exceeds a threshold.

25. The computer-implemented method of claim 24, wherein calculating a factor further comprises calculating the factor using an aggregates on aggregates computation.

26. A break detection method for analyzing a behavior of a participant in a market to determine the probability of a predetermined behavior, comprising:
extracting targeted information from a data source received information;
organizing the extracted in an information form in a database;
computing summary and profile information describing the activity on an issue in the market;
storing the summary and profile information in the database;
selecting a theta equation based on the presence of one or more factors and one or more conditions associated with the equation;
solving the selected equation using information stored in the database relating to the market participant, the solution representing a probability that the predetermined behavior has occurred with respect to the issue in the market; and
adjusting the probability based on the application of one or more expert rules.
